(19) United States
(12) Patent Application Publication
(10) Pub. No.: US 2026/0116498 A1
(43) Pub. Date: Apr. 30, 2026

(54) RELAY UNIT AND HUMAN-POWERED VEHICLE SYSTEM

(71) Applicant: SHIMANO INC., Sakai City (JP)

(72) Inventors: Yu ISHII, Sakai City (JP); Takeyuki IGUCHI, Sakai City (JP)

(73) Assignee: SHIMANO INC., Sakai City (JP)

(21) Appl. No.: 18/931,000

(22) Filed: Oct. 29, 2024

(51) Int. Cl. B62M 25/08; B62J 45/411; B62M 6/50

(52) U.S. Cl. CPC B62M 25/08; B62M 6/50; B62J 45/411

(57) ABSTRACT

A relay unit comprises first interface circuitry, second interface circuitry, and controller circuitry. The first interface circuitry is configured to be electrically connected to an assist drive unit of a human-powered vehicle. The assist drive unit is configured to assist propulsion of the human-powered vehicle. The second interface circuitry is configured to be electrically connected to a transmission device of the human-powered vehicle. The transmission device is configured to execute a gear shifting of the human-powered vehicle. The controller circuitry is electrically connected to the first interface circuitry and the second interface circuitry. The controller circuitry is configured to receive information relating to the human-powered vehicle from a sensor configured to detect the information. The controller circuitry is configured to change a timing of the gear shifting of the transmission device based on the information.

### BACKGROUND

### Technical Field

The present invention relates to a relay unit and a human-powered vehicle system.

### Background Information

A human-powered vehicle includes an assist drive unit and a transmission device. The assist drive unit assists propulsion of the human-powered vehicle. The transmission device executes gear shifting. Greater assist power may make the gear shifting difficult to be smoothly executed because of excessive tension of a chain. One of objects of the present disclosure is to smoothen the gear shifting. Another of objects of the present disclosure is to make it easier to synchronize the assist drive unit and the transmission device.

### SUMMARY

In accordance with a first aspect of the present invention, a relay unit comprises first interface circuitry, second interface circuitry, and controller circuitry. The first interface circuitry is configured to be electrically connected to an assist drive unit of a human-powered vehicle. The assist drive unit is configured to assist propulsion of the human-powered vehicle. The second interface circuitry is configured to be electrically connected to a transmission device of the human-powered vehicle. The transmission device is configured to execute a gear shifting of the human-powered vehicle. The controller circuitry is electrically connected to the first interface circuitry and the second interface circuitry. The controller circuitry is configured to receive information relating to the human-powered vehicle from a sensor configured to detect the information. The controller circuitry is configured to change a timing of the gear shifting of the transmission device based on the information.

With the relay unit according to the first aspect, it is possible to change the timing of the gear shifting based on the information relating to the human-powered vehicle. Thus, it is possible to smoothen the gear shifting.

In accordance with a second aspect of the present invention, the relay unit according to the first aspect is configured so that the controller circuitry is configured to change the timing of the gear shifting to a target timing at which pedaling torque applied to a crank of the human-powered vehicle is lower than a pedaling torque threshold.

With the relay unit according to the second aspect, it is possible to execute the gear shifting at the target timing at which the pedaling torque applied to the crank of the human-powered vehicle is lower than the pedaling torque threshold. Thus, it is possible to reliably smoothen the gear shifting.

In accordance with a third aspect of the present invention, the relay unit according to the second aspect is configured so that the controller circuitry is configured to calculate the target timing of the gear shifting based on the information.

With the relay unit according to the third aspect, it is possible to more reliably smoothen the gear shifting.

In accordance with a fourth aspect of the present invention, the relay unit according to the third aspect is configured so that the controller circuitry is configured to transmit, to the transmission device via the second interface circuitry based on the information, a gear-shifting signal such that the transmission device executes the gear shifting at the target timing calculated by the controller circuitry.

With the relay unit according to the fourth aspect, it is possible to reliably execute the gear shifting at the target timing. Thus, it is possible to more reliably smoothen the gear shifting.

In accordance with a fifth aspect of the present invention, the relay unit according to any one of the first to fourth aspects is configured so that the assist drive unit is configured to generate assist torque to assist the propulsion of the human-powered vehicle. The controller circuitry is configured to transmit, to the assist drive unit via the first interface circuitry based on the information, a torque control signal such that the assist drive unit changes the assist torque.

With the relay unit according to the fifth aspect, it is possible to change the assist torque depending on the state of the human-powered vehicle based on the information. Thus, it is possible to reliably smoothen the gear shifting by changing the assist torque.

In accordance with a sixth aspect of the present invention, the relay unit according to the fifth aspect is configured so that the controller circuitry is configured to transmit, to the assist drive unit via the first interface circuitry based on the information, the torque control signal such that the assist drive unit reduces the assist torque.

With the relay unit according to the sixth aspect, it is possible to more reliably smoothen the gear shifting by reducing the assist torque.

In accordance with a seventh aspect of the present invention, the relay unit according to the sixth aspect is configured so that the assist drive unit is configured to limit the assist torque to an upper limit in a case where the assist torque reaches the upper limit. The controller circuitry is configured to transmit, to the assist drive unit via the first interface circuitry based on the information, the torque control signal such that the assist drive unit reduces the upper limit.

With the relay unit according to the seventh aspect, it is possible to more reliably smoothen the gear shifting using the upper limit while maintaining the necessary assist torque.

In accordance with an eighth aspect of the present invention, the relay unit according to any one of the first to seventh aspects is configured so that the information includes crank information relating to a crank of the human-powered vehicle. The controller circuitry is configured to change the timing of the gear shifting based on the crank information.

With the relay unit according to the eighth aspect, it is possible to reliably smoothen the gear shifting based on the crank information relating to the crank.

In accordance with a ninth aspect of the present invention, the relay unit according to the eighth aspect is configured so that the crank information relates to at least one of pedaling torque applied to the crank and a rotational position of the crank. The controller circuitry is configured to change the timing of the gear shifting based on the at least one of the pedaling torque and the rotational position.

With the relay unit according to the ninth aspect, it is possible to more reliably smoothen the gear shifting using the pedaling torque and the rotational position of the crank.

In accordance with a tenth aspect of the present invention, the relay unit according to the ninth aspect is configured so that the crank information relates to at least one of: a first prediction timing at which the pedaling torque becomes minimum; and a second prediction timing at which a crank arm of the crank is positioned in one of a top dead center and a bottom dead center. The controller circuitry is configured to change the timing of the gear shifting based on the at least one of the first prediction timing and the second prediction timing.

With the relay unit according to the tenth aspect, it is possible to reliably execute the gear shifting when the pedaling torque becomes minimum and/or when the crank arm is in one of the top dead center and the bottom dead center. Thus, it is possible to smoothen the gear shifting.

In accordance with an eleventh aspect of the present invention, the relay unit according to any one of the first to tenth aspects is configured so that the controller circuitry is configured to receive the information from the assist drive unit via the first interface circuitry using a first communication protocol.

With the relay unit according to the eleventh aspect, it is possible to establish the communication between the relay unit and the assist drive unit using the first communication protocol. Thus, the controller circuitry can receive the information from the assist drive unit smoothly.

In accordance with a twelfth aspect of the present invention, the relay unit according to the eleventh aspect is configured so that the controller circuitry is configured to receive gear-shifting information from the transmission device via the second interface circuitry using a second communication protocol. The second communication protocol is different from the first communication protocol.

With the relay unit according to the twelfth aspect, it is possible to establish the communication between the relay unit and the transmission device using the second communication protocol different from the first communication protocol. Thus, the controller circuitry can receive the gear-shifting information from the transmission device smoothly while the second communication protocol is different from the first communication protocol.

In accordance with a thirteenth aspect of the present invention, the relay unit according to any one of the first to twelfth aspects is configured so that the controller circuitry is configured to receive gear-shifting information from the transmission device via the second interface circuitry. The gear-shifting information relates to the gear shifting of the transmission device.

With the relay unit according to the thirteenth aspect, it is possible to control the transmission device using the gear-shifting information.

In accordance with a fourteenth aspect of the present invention, the relay unit according to the thirteenth aspect is configured so that the controller circuitry is configured to change the timing of the gear shifting of the transmission device based on the information and the gear-shifting information.

With the relay unit according to the fourteenth aspect, the information and the gear-shifting information enable the controller circuitry to synchronize the timing of the gear shifting and the motion of a component of the human-powered vehicle such as the crank.

In accordance with a fifteenth aspect of the present invention, the relay unit according to any one of the first to fourteenth aspects is configured so that the controller circuitry is configured to calculate, based on the information, a signal transmission timing at which the controller circuitry transmits a gear-shifting signal to the transmission device via the second interface circuitry.

With the relay unit according to the fifteenth aspect, it is possible to improve the accuracy of the signal transmission timing using the information.

In accordance with a sixteenth aspect of the present invention, a relay unit comprises interface circuitry and controller circuitry. The interface circuitry is configured to be electrically connected to at least one of a first assist drive unit of a human-powered vehicle and a transmission device of the human-powered vehicle. The first assist drive unit is configured to assist propulsion of the human-powered vehicle. The transmission device is configured to execute a gear shifting of the human-powered vehicle. The interface circuitry is configured to be electrically connected to a second assist drive unit instead of the first assist drive unit. The second assist drive unit is different from the first assist drive unit. The controller circuitry is electrically connected to the interface circuitry and a sensor. The sensor is configured to detect first crank information relating to a crank of the human-powered vehicle. The controller circuitry is configured to receive the first crank information via the sensor. The controller circuitry is configured to transmit at least one of the first crank information and second crank information to one of the first assist drive unit, the second assist drive unit and the transmission device via the interface circuitry. The second crank information relates to the crank of the human-powered vehicle.

With the relay unit according to the sixteenth aspect, it is possible to smoothen the gear shifting using the first crank information and the second crank information.

In accordance with a seventeenth aspect of the present invention, the relay unit according to the sixteenth aspect is configured so that the controller circuitry is configured to transmit the first crank information and the second crank information to one of the first assist drive unit, the second assist drive unit and the transmission device of the human-powered vehicle via the interface circuitry.

With the relay unit according to the seventeenth aspect, it is possible to share the first crank information and the second crank information between the relay unit and at least one of the first assist drive unit, the second assist drive unit, and the transmission device. This makes it easier to synchronize the relay unit and at least one of the first assist drive unit, the second assist drive unit, and the transmission device.

In accordance with an eighteenth aspect of the present invention, a relay unit comprises interface circuitry and controller circuitry. The interface circuitry is configured to be electrically connected to at least one of a first assist drive unit of a human-powered vehicle and a transmission device of the human-powered vehicle. The first assist drive unit is configured to assist propulsion of the human-powered vehicle. The transmission device is configured to execute a gear shifting of the human-powered vehicle. The interface circuitry is electrically connectable a second assist drive unit instead of the first assist drive unit. The second assist drive unit is different from the first assist drive unit. The controller circuitry is electrically connected to the interface circuitry and a sensor. The sensor is configured to detect first crank information relating to a crank of the human-powered vehicle. The controller circuitry is configured to receive the first crank information via the sensor. The controller circuitry is configured to, based on the first crank information, generate a control signal that controls at least one of the first assist drive unit, the second assist drive unit and the transmission device of the human-powered vehicle.

With the relay unit according to the eighteenth aspect, it is possible to control the at least one of the first assist drive unit, the second assist drive unit and the transmission device of the human-powered vehicle based on the first crank information relating to the crank. This makes it easier to synchronize the relay unit and at least one of the first assist drive unit, the second assist drive unit, and the transmission device.

In accordance with a nineteenth aspect of the present invention, the relay unit according to the eighteenth aspect is configured so that the controller circuitry is configured to transmit the control signal to one of the first assist drive unit, the second assist drive unit and the transmission device of the human-powered vehicle via the interface circuitry.

With the relay unit according to the nineteenth aspect, it is possible to reliably make it easier to synchronize the relay unit and at least one of the first assist drive unit, the second assist drive unit, and the transmission device.

In accordance with a twentieth aspect of the present invention, a human-powered vehicle system comprises the relay unit according to any one of the first to nineteenth aspects, the assist drive unit configured to be electrically connected to the relay unit, and the transmission device configured to be electrically connected to the relay unit.

With the human-powered vehicle system according to the twenties aspect, it is possible to smoothen the gear shifting and/or to make it easier to synchronize the relay unit and the at least one of the first assist drive unit, the second assist drive unit, and the transmission device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a human-powered vehicle system in accordance with one of embodiments.

FIG. 2 is a side elevational view of an assist drive unit of the human-powered vehicle system illustrated in FIG. 1.

FIG. 3 is a schematic block diagram of the human-powered vehicle system including a relay unit in accordance with one of embodiments.

FIG. 4 is a side elevational view of an operating device of the human-powered vehicle system illustrated in FIG. 3.

FIG. 5 is a side elevational view of a transmission device of the human-powered vehicle system illustrated in FIG. 3.

FIG. 6 is a side elevational view of an operating device of the human-powered vehicle system illustrated in FIG. 3.

FIG. 7 is a schematic block diagram of the human-powered vehicle system illustrated in FIG. 3.

FIGS. 8 to 11 are schematic diagrams showing the control of the human-powered vehicle system illustrated in FIG. 3.

FIG. 12 is a schematic diagram showing a comparative example of timing at which a gear-shifting signal is transmitted to the transmission device.

FIGS. 13 and 14 are flowcharts showing the control of the human-powered vehicle system illustrated in FIG. 3.

FIGS. 15 to 17 are schematic diagrams showing the control of the human-powered vehicle system illustrated in FIG. 3.

FIG. 18 is a schematic block diagram of a human-powered vehicle system including a relay unit in accordance with a modification.

FIG. 19 is a flowchart showing the control of the human-powered vehicle system illustrated in FIG. 18.

### DESCRIPTION OF THE EMBODIMENTS

The embodiments will now be described with reference to the accompanying drawings, wherein like reference numerals designate corresponding or identical elements throughout the various drawings.

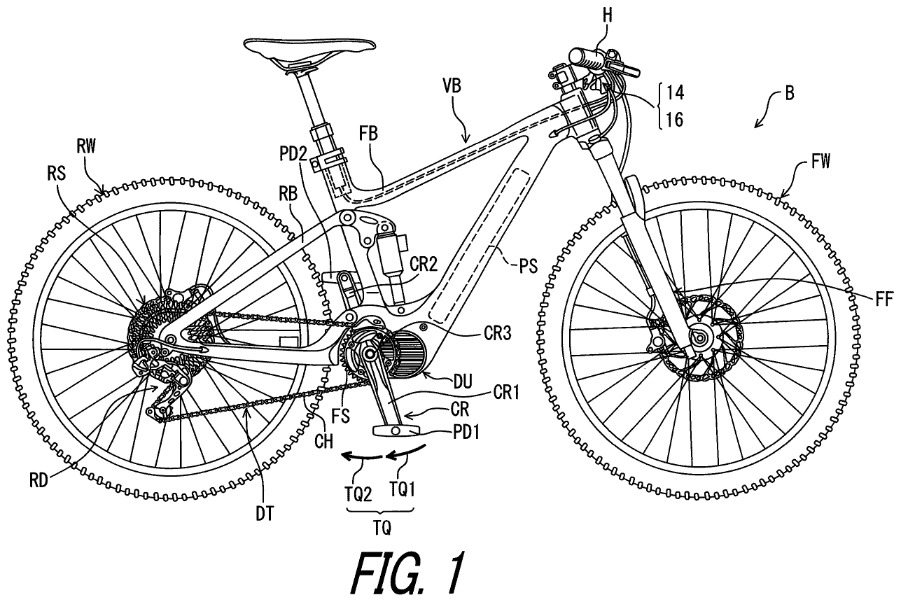

Referring initially to FIG. 1, a human-powered vehicle B includes a human-powered vehicle system 10 in accordance with one of embodiments. In the present application, the term “human-powered vehicle” includes a vehicle to travel with a motive power including at least human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

As seen in FIG. 1, the human-powered vehicle B includes a vehicle body VB, a wheel FW, and a wheel RW. The wheel FW is rotatably coupled to the vehicle body VB. The wheel RW is rotatably coupled to the vehicle body VB. The vehicle body VB is supported by the wheels FW and RW. The wheel FW can also be referred to as a front wheel FW. The wheel RW can also be referred to as a rear wheel RW.

The vehicle body VB includes a front frame body FB, a rear frame body RB, a handlebar H, and a front fork FF. The rear frame body RB includes a swing arm. The rear frame body RB is movably coupled to the front frame body FB. The rear frame body RB is pivotally coupled to the front frame body FB. The front fork FF is pivotally coupled to the front frame body FB. The handlebar H is coupled to the front fork FF to be pivotable relative to the front frame body FB along with the front fork FF.

The human-powered vehicle B further includes a drivetrain DT. The drivetrain DT includes a crank CR, at least one front sprocket FS, at least two rear sprockets RS, a chain CH, and pedals PD1 and PD2. The crank CR is rotatably coupled to the vehicle body VB. The crank CR includes crank arms CR1 and CR2 and a crank axle CR3. The crank arms CR1 and CR2 are coupled with ends of the crank axle CR3. The at least one front sprocket FS is coupled to the crank CR to rotate relative to the vehicle body VB along with the crank CR. The at least two rear sprockets RS are provided on a hub assembly of the wheel RW. The chain CH is configured to be engaged with one of the at least one front sprocket FS and one of the at least two rear sprockets RS.

The pedal PD1 is coupled to an end of the crank arm CR1. The pedal PD2 is coupled to an end of the crank arm CR2. Pedaling torque TQ1 is applied to the crank CR via the pedals PD1 and PD2 by a rider such that the pedaling torque TQ1 is transmitted to the wheel RW via the at least one front sprocket FS, the chain CH, and the at least two rear sprockets RS. While the human-powered vehicle B includes a chain-drive type of drivetrain, the human-powered vehicle B can include another type of drivetrain such as a belt-drive type or a shaft-drive type.

The human-powered vehicle system 10 comprises an assist drive unit DU. The assist drive unit DU is mounted to the vehicle body VB. The assist drive unit DU is configured to assist propulsion of the human-powered vehicle B. The assist drive unit DU is configured to apply assist torque TQ2 to the drivetrain DT. The assist drive unit DU is configured to change an assist ratio depending on the human power applied to the human-powered vehicle B. For example, the assist drive unit DU is configured to change the assist ratio depending on the pedaling torque TQ1 applied to the crank CR. The assist ratio is a ratio of the assist torque TQ2 to the pedaling torque TQ1.

The human-powered vehicle system 10 comprises a transmission device RD. The transmission device RD is mounted to the vehicle body VB. The transmission device RD is configured to shift the chain CH relative to the at least two rear sprockets RS. The transmission device RD is configured to execute gear shifting of the human-powered vehicle B. The transmission device RD is configured to change a gear ratio of the human-powered vehicle B. The gear ratio is a ratio of a rotational speed of the at least two rear sprockets RS to a rotational speed of the at least one front sprocket FS.

The transmission device RD has at least two gear stages having at least two gear ratios, respectively. The transmission device RD is configured to change the current gear ratio among the at least two gear ratios. The transmission device RD is configured to change a current gear stage among the at least two gear stages. For example, the transmission device RD is configured to shift the chain CH relative to the at least two rear sprockets RS. In the present embodiment, the transmission device RD includes a rear derailleur. Alternatively, the transmission device RD can include another type of transmission device. Examples of another type of transmission device RD include a front derailleur and an internal-gear hub.

The human-powered vehicle B includes an electric power source PS. The electric power source PS is configured to be store electricity. The electric power source PS includes a battery. Examples of the battery include a primary battery and a secondary battery. The electric power source PS is configured to supply electricity to at least the assist drive unit DU and the transmission device RD. The electric power source PS is electrically connected to the assist drive unit DU. The electric power source PS is electrically connected to the transmission device RD via the assist drive unit DU. However, the transmission device RD can have its own electric power source such as a battery.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle B while the user faces toward a handlebar or steering. Examples of the user's standard position include a saddle and a seat. Accordingly, these terms, as utilized to describe the human-powered vehicle system 10 or other components, should be interpreted relative to the human-powered vehicle B equipped with the human-powered vehicle system 10 or other components as used in an upright riding position on a horizontal surface.

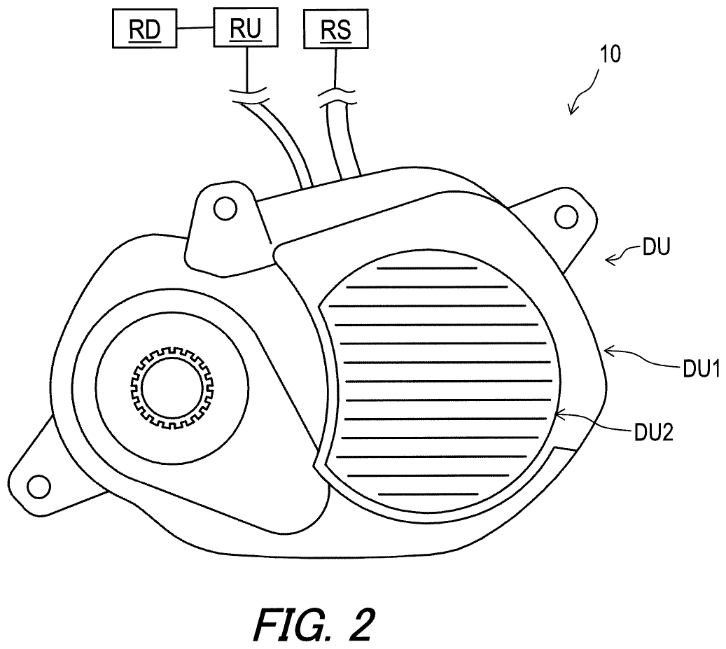

As seen in FIG. 2, the assist drive unit DU comprises a housing DU1 and an electric actuator DU2. The electric actuator DU2 is at least partially provided in the housing DU1. The electric actuator DU2 is configured to generate the pedaling torque TQ1. Examples of the electric actuator DU2 include an electric motor. The electric actuator DU2 is configured to apply the pedaling torque TQ1 to the human-powered vehicle B to assist propulsion of the human-powered vehicle B.

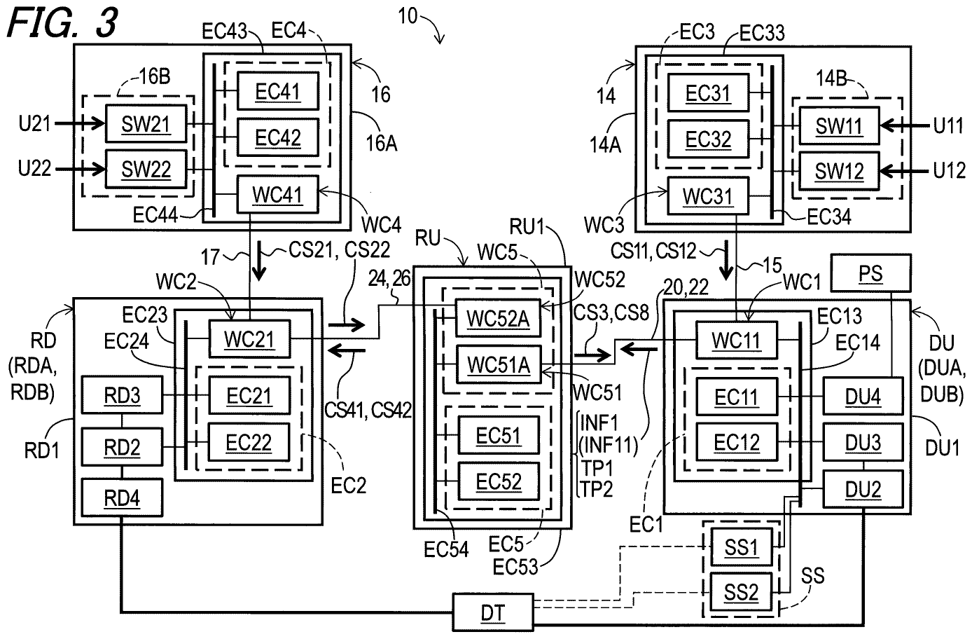

As seen in FIG. 3, the assist drive unit DU comprises first controller circuitry EC1 and an actuator driver DU3. The first controller circuitry EC1 is electrically connected to the electric actuator DU2 via the actuator driver DU3. The first controller circuitry EC1 is configured to control the electric actuator DU2 via the actuator driver DU3. The first controller circuitry EC1 is configured to generate a control command which is indicative of output torque such as the assist torque TQ2. The actuator driver DU3 is electrically connected to the electric actuator DU2 to control the electric actuator DU2 based on the control signal.

The first controller circuitry EC1 includes at least one processor EC11 and at least one memory EC12. The first controller circuitry EC1 includes at least one circuit board EC13 and at least one system bus EC14. The first controller circuitry EC1 is electrically mounted on the at least one circuit board EC13. The at least one processor EC11 and the at least one memory EC12 are electrically mounted on the at least one circuit board EC13. The at least one processor EC11 is coupled to the at least one memory EC12. The at least one memory EC12 is coupled to the at least one processor EC11. The at least one processor EC11 is electrically connected to the at least one memory EC12 via the at least one circuit board EC13 and the at least one system bus EC14. The at least one memory EC12 is electrically connected to the at least one processor EC11 via the at least one circuit board EC13 and the at least one system bus EC14. For example, the first controller circuitry EC1 includes at least one semiconductor. The at least one processor EC11 includes at least one semiconductor. The at least one memory EC12 includes at least one semiconductor.

For example, the at least one processor EC11 includes at least one of a central processing unit (CPU), a micro processing unit (MPU), a graphics processing unit (GPU), and a memory controller. The at least one memory EC12 is electrically connected to the at least one processor EC11. For example, the at least one memory EC12 includes at least one of a volatile memory and a non-volatile memory. Examples of the volatile memory include a random-access memory (RAM) and a dynamic random-access memory (DRAM).

Examples of the non-volatile memory include a read only memory (ROM), an electrically erasable programmable ROM (EEPROM), and a magnetic disc. The at least one memory EC12 includes storage areas each having an address. The at least one processor EC11 is configured to control the at least one memory EC12 to store data in the storage areas of the at least one memory EC12 and reads data from the storage areas of the at least one memory EC12. The at least one processor EC11 can also be referred to as at least one hardware processor EC11, at least one processor circuit EC11, or processor circuitry EC11. The at least one memory EC12 can also be referred to as at least one hardware memory EC12, at least one memory circuit, or memory circuitry EC12. The at least one memory EC12 can also be referred to as a non-transitory computer-readable storage medium EC12. Namely, the first controller circuitry EC1 includes the non-transitory computer-readable storage medium EC12. The first controller circuitry EC1 can also be referred to as first electronic controller circuitry.

The first controller circuitry EC1 is configured to execute at least one control algorithm of the assist drive unit DU. For example, the first controller circuitry EC1 is programed to execute at least one control algorithm of the assist drive unit DU. The at least one memory EC12 stores at least one program including at least one computer program code. The at least one program is read into the at least one processor EC11, and thereby the at least one control algorithm of the assist drive unit DU is executed based on the at least one program.

The structure of the first controller circuitry EC1 is not limited to the above structure. The structure of the first controller circuitry EC1 is not limited to the at least one processor EC11 and the at least one memory EC12. The first controller circuitry EC1 can be realized by hardware alone, software alone, or a combination of hardware and software. In the present embodiment, the at least one processor EC11 and the at least one memory EC12 can be separate chips. Alternatively, the at least one processor EC11 and the at least one memory EC12 can be integrated as a single chip such as an application specific integrated circuit (ASIC) or a field programmable gate array (FPGA).

The first controller circuitry EC1 can include at least two electronic controller circuits which are separately provided. The at least one control algorithm of the assist drive unit DU can be executed by the at least two electronic controller circuits if needed or desired. The first controller circuitry EC1 can include at least two processors which are separately provided. The first controller circuitry EC1 can include at least two memories which are separately provided. The at least one control algorithm of the assist drive unit DU can be executed by the at least two processors if needed or desired. The at least one control algorithm of the assist drive unit DU can be stored in the at least two memories if needed or desired. The first controller circuitry EC1 can include at least two circuit boards which are separately provided if needed or desired. The first controller circuitry EC1 can include at least two system buses which are separately provided if needed or desired.

As seen in FIG. 3, the human-powered vehicle B includes an operating device 14. The operating device 14 is electrically connected to the first controller circuitry EC1 of the assist drive unit DU via an electrical cable 15. Alternatively, the operating device 14 can be electrically connected to the assist drive unit DU wirelessly.

The operating device 14 is configured to receive an assist user input U11. The operating device 14 is configured to receive an assist user input U12. For example, the assist user input U11 is indicative of an increase in the assist ratio of the assist drive unit DU. The assist user input U12 is indicative of a decrease in the assist ratio of the assist drive unit DU.

The first controller circuitry EC1 of the assist drive unit DU is configured to change the assist ratio in response to the assist user input U11 and/or U12. The first controller circuitry EC1 is configured to increase the assist ratio in response to the assist user input U11. The first controller circuitry EC1 is configured to decrease the assist ratio in response to the assist user input U12. The first controller circuitry EC1 is configured to increase the assist torque TQ2 in response to the assist user input U11. The first controller circuitry EC1 is configured to decrease the assist torque TQ2 in response to the assist user input U12.

The first controller circuitry EC1 has at least two different assist ratios. For example, the first controller circuitry EC1 has a first assist ratio, a second assist ratio, and a third assist ratio. The first assist ratio is higher than the second assist ratio and the third assist ratio. The second assist ratio is higher than the third assist ratio. The first controller circuitry EC1 is configured to select, as the assist ratio, one of the first assist ratio, the second assist ratio, and the third assist ratio.

The first controller circuitry EC1 is configured to decrease the assist ratio from the first assist ratio to the second assist ratio in response to the assist user input U12. The first controller circuitry EC1 is configured to decrease the assist ratio from the second assist ratio to the third assist ratio in response to the assist user input U12. The first controller circuitry EC1 is configured to increase the assist ratio from the third assist ratio to the second assist ratio in response to the assist user input U11. The first controller circuitry EC1 is configured to increase the assist ratio from the second assist ratio to the first assist ratio in response to the assist user input U11.

The first controller circuitry EC1 is configured to calculate the assist torque TQ2 based on the pedaling torque TQ1 and the selected assist ratio (e.g., one of the first assist ratio, the second assist ratio, and the third assist ratio). The first controller circuitry EC1 is configured to calculate the assist torque TQ2 based on the pedaling torque TQ1 and the selected assist ratio at a predetermined cycle. The first controller circuitry EC1 is configured to apply the calculated assist torque TQ2 to the drivetrain DT. For example, the electric actuator DU2 is coupled to the drivetrain DT. The first controller circuitry EC1 is configured to control the electric actuator DU2 to apply the calculated assist torque TQ2 to the drivetrain DT.

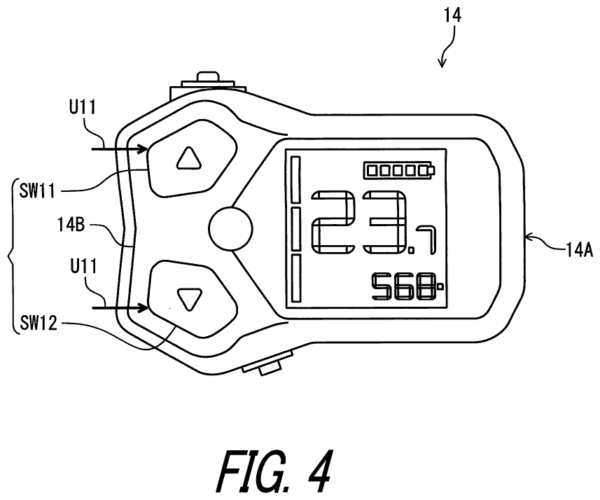

As seen in FIG. 4, the operating device 14 includes a housing 14A and a user interface 14B. The housing 14A is mountable to the vehicle body VB of the human-powered vehicle B. The user interface 14B is configured to be operated by the user to control the assist drive unit DU while the human-powered vehicle B is running. The user interface 14B is configured to receive the assist user input U11 or U12. For example, the user interface 14B includes a switch SW11 configured to be activated in response to the assist user input U11. The user interface 14B includes a switch SW12 configured to be activated in response to the assist user input U12.

As seen in FIG. 3, the operating device 14 comprises third controller circuitry EC3. The third controller circuitry EC3 is electrically connected to the user interface 14B to receive the assist user input U11 or U12 via the user interface 14B. The third controller circuitry EC3 is electrically connected to the switch SW11 to detect the activation of the switch SW11 caused by the assist user input U11. The third controller circuitry EC3 is electrically connected to the switch SW12 to detect the activation of the switch SW12 caused by the assist user input U12. The third controller circuitry EC3 is configured to generate a control signal CS11 in response to the assist user input U11. The third controller circuitry EC3 is configured to generate a control signal CS12 in response to the assist user input U12.

The third controller circuitry EC3 includes at least one processor EC31 and at least one memory EC32. The third controller circuitry EC3 includes at least one circuit board EC33 and at least one system bus EC34. The third controller circuitry EC3 is electrically mounted on the at least one circuit board EC33. The at least one processor EC31 and the at least one memory EC32 are electrically mounted on the at least one circuit board EC33. The at least one processor EC31 is coupled to the at least one memory EC32. The at least one memory EC32 is coupled to the at least one processor EC31. The at least one processor EC31 is electrically connected to the at least one memory EC32 via the at least one circuit board EC33 and the at least one system bus EC34. The at least one memory EC32 is electrically connected to the at least one processor EC31 via the at least one circuit board EC33 and the at least one system bus EC34. For example, the third controller circuitry EC3 includes at least one semiconductor. The at least one processor EC31 includes at least one semiconductor. The at least one memory EC32 includes at least one semiconductor.

For example, the at least one processor EC31 includes at least one of a central processing unit (CPU), a micro processing unit (MPU), a graphics processing unit (GPU), and a memory controller. The at least one memory EC32 is electrically connected to the at least one processor EC31. For example, the at least one memory EC32 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The at least one memory EC32 includes storage areas each having an address. The at least one processor EC31 is configured to control the at least one memory EC32 to store data in the storage areas of the at least one memory EC32 and reads data from the storage areas of the at least one memory EC32. The at least one processor EC31 can also be referred to as at least one hardware processor EC31, at least one processor circuit EC31, or processor circuitry EC31. The at least one memory EC32 can also be referred to as at least one hardware memory EC32, at least one memory circuit, or memory circuitry EC32. The at least one memory EC32 can also be referred to as a non-transitory computer-readable storage medium EC32. Namely, the third controller circuitry EC3 includes the non-transitory computer-readable storage medium EC32. The third controller circuitry EC3 can also be referred to as first electronic controller circuitry.

The third controller circuitry EC3 is configured to execute at least one control algorithm of the operating device 14. For example, the third controller circuitry EC3 is programed to execute at least one control algorithm of the operating device 14. The at least one memory EC32 stores at least one program including at least one computer program code. The at least one program is read into the at least one processor EC31, and thereby the at least one control algorithm of the operating device 14 is executed based on the at least one program.

The structure of the third controller circuitry EC3 is not limited to the above structure. The structure of the third controller circuitry EC3 is not limited to the at least one processor EC31 and the at least one memory EC32. The third controller circuitry EC3 can be realized by hardware alone, software alone, or a combination of hardware and software. In the present embodiment, the at least one processor EC31 and the at least one memory EC32 can be separate chips. Alternatively, the at least one processor EC31 and the at least one memory EC32 can be integrated as a single chip such as an application specific integrated circuit (ASIC) or a field programmable gate array (FPGA).

The third controller circuitry EC3 can include at least two electronic controller circuits which are separately provided. The at least one control algorithm of the operating device 14 can be executed by the at least two electronic controller circuits if needed or desired. The third controller circuitry EC3 can include at least two processors which are separately provided. The third controller circuitry EC3 can include at least two memories which are separately provided. The at least one control algorithm of the operating device 14 can be executed by the at least two processors if needed or desired. The at least one control algorithm of the operating device 14 can be stored in the at least two memories if needed or desired. The third controller circuitry EC3 can include at least two circuit boards which are separately provided if needed or desired. The third controller circuitry EC3 can include at least two system buses which are separately provided if needed or desired.

The human-powered vehicle system 10 includes a sensor SS configured to detect information INF1 relating to the human-powered vehicle B. In the present embodiment, the information INF1 includes crank information INF11 relating to the crank CR of the human-powered vehicle B. The sensor SS is configured to detect the crank information INF11. For example, the crank information INF11 relates to at least one of: the pedaling torque TQ1 applied to the crank CR; and a rotational position of the crank CR. The sensor SS is configured to detect at least one of the pedaling torque TQ1 and the rotational position of the crank CR. The information INF1 relating to the human-powered vehicle B can include information relating to at least one of a front hub drive motor and a rear hub drive motor.

In the present embodiment, the sensor SS is configured to detect the pedaling torque TQ1 applied to the crank CR from the rider. For example, the sensor SS includes a force sensor SS1 configured to detect force applied to the crank CR. The force sensor SS1 includes a strain gauge configured to detect a deformation amount of the crank CR. The force sensor SS1 can be provided to at least one of the crank arm CR1, the crank arm CR2, and the crank axle CR3.

The sensor SS is configured to detect the rotational position of the crank CR. For example, the sensor SS includes a position sensor SS2 configured to detect the rotational position of the crank CR. The position sensor SS2 includes an acceleration sensor configured to first acceleration, second acceleration, and third acceleration. The first acceleration is applied to the crank CR along a vertical direction of the crank CR. The second acceleration is applied to the crank CR along a radial direction of the crank CR. The third acceleration is applied to a circumferential direction of the crank CR. The relationship between the first acceleration, the second acceleration, and the third acceleration indicates the rotational position of the crank CR. The position sensor SS2 can be provided to at least one of the assist drive unit DU and the crank CR. Alternatively, the position sensor SS2 can be provided to another device other than at least one of the assist drive unit DU and the crank CR.

The first controller circuitry EC1 is electrically connected to the sensor SS to receive the information INF1 detected by the sensor SS. The first controller circuitry EC1 is electrically connected to the sensor SS to receive the crank information INF1I detected by the sensor SS.

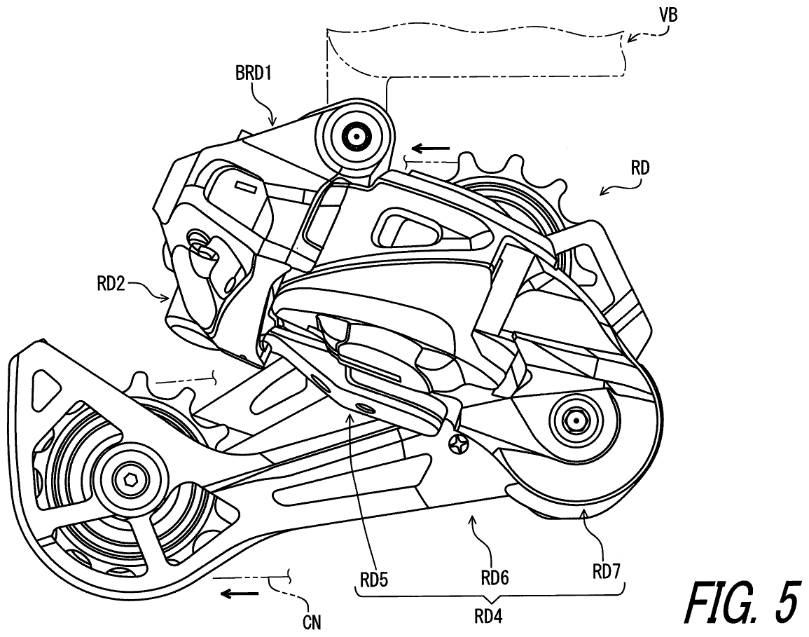

As seen in FIG. 5, the transmission device RD further comprises a base member RD1 and a movable structure RD4. The base member RD1 is mountable to the vehicle body VB. The movable structure RD4 is movable relative to the base member RD1. For example, the movable structure RD4 includes a linkage RD5, a chain guide RD6, and a movable member RD7. The chain guide RD6 is contactable with the chain CH. The linkage RD5 movably couples the base member RD1 and the movable member RD7. The chain guide RD6 is pivotally coupled to the movable member RD7.

The transmission device RD comprises an electric actuator RD2. The electric actuator RD2 is configured to generate actuation force. Examples of the electric actuator RD2 include an electric motor. The electric actuator RD2 is coupled to at least one of the base member RD1 and the movable structure RD4 to move the movable structure RD4 relative to the base member RD1. The electric actuator RD2 is at least partially provided to at least one of the base member RD1, the movable structure RD4, the linkage RD5, the chain guide RD6, and the movable member RD7. The electric actuator RD2 can be configured to be controlled based on a control signal transmitted from another device or to be automatically controlled based on information relating to the human-powered vehicle B.

As seen in FIG. 3, the transmission device RD comprises second controller circuitry EC2 and an actuator driver RD3. The second controller circuitry EC2 is electrically connected to the electric actuator RD2 via the actuator driver RD3. The actuator driver RD3 is electrically connected to the electric actuator RD2 to control the electric actuator RD2. The second controller circuitry EC2 is configured to control the electric actuator RD2 via the actuator driver RD3. The second controller circuitry EC2 is configured to generate a control signal. The control signal is indicative of output torque and a rotational direction. The actuator driver RD3 is configured to control the electric actuator RD2 based on the control signal.

The second controller circuitry EC2 includes at least one processor EC21 and at least one memory EC22. The second controller circuitry EC2 includes at least one circuit board EC23 and at least one system bus EC24. The second controller circuitry EC2 is electrically mounted on the at least one circuit board EC23. The at least one processor EC21 and the at least one memory EC22 are electrically mounted on the at least one circuit board EC23. The at least one processor EC21 is coupled to the at least one memory EC22. The at least one memory EC22 is coupled to the at least one processor EC21. The at least one processor EC21 is electrically connected to the at least one memory EC22 via the at least one circuit board EC23 and the at least one system bus EC24. The at least one memory EC22 is electrically connected to the at least one processor EC21 via the at least one circuit board EC23 and the at least one system bus EC24. For example, the second controller circuitry EC2 includes at least one semiconductor. The at least one processor EC21 includes at least one semiconductor. The at least one memory EC22 includes at least one semiconductor.

For example, the at least one processor EC21 includes at least one of a central processing unit (CPU), a micro processing unit (MPU), a graphics processing unit (GPU), and a memory controller. The at least one memory EC22 is electrically connected to the at least one processor EC21. For example, the at least one memory EC22 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The at least one memory EC22 includes storage areas each having an address. The at least one processor EC21 is configured to control the at least one memory EC22 to store data in the storage areas of the at least one memory EC22 and reads data from the storage areas of the at least one memory EC22. The at least one processor EC21 can also be referred to as at least one hardware processor EC21, at least one processor circuit EC21, or processor circuitry EC21. The at least one memory EC22 can also be referred to as at least one hardware memory EC22, at least one memory circuit, or memory circuitry EC22. The at least one memory EC22 can also be referred to as a non-transitory computer-readable storage medium EC22. Namely, the second controller circuitry EC2 includes the non-transitory computer-readable storage medium EC22. The second controller circuitry EC2 can also be referred to as second electronic controller circuitry.

The second controller circuitry EC2 is configured to execute at least one control algorithm of the transmission device RD. For example, the second controller circuitry EC2 is programed to execute at least one control algorithm of the transmission device RD. The at least one memory EC22 stores at least one program including at least one computer program code. The at least one program is read into the at least one processor EC21, and thereby the at least one control algorithm of the transmission device RD is executed based on the at least one program.

The structure of the second controller circuitry EC2 is not limited to the above structure. The structure of the second controller circuitry EC2 is not limited to the at least one processor EC21 and the at least one memory EC22. The second controller circuitry EC2 can be realized by hardware alone, software alone, or a combination of hardware and software. In the present embodiment, the at least one processor EC21 and the at least one memory EC22 can be separate chips. Alternatively, the at least one processor EC21 and the at least one memory EC22 can be integrated as a single chip such as an application specific integrated circuit (ASIC) or a field programmable gate array (FPGA).

The second controller circuitry EC2 can include at least two electronic controller circuits which are separately provided. The at least one control algorithm of the transmission device RD can be executed by the at least two electronic controller circuits if needed or desired. The second controller circuitry EC2 can include at least two processors which are separately provided. The second controller circuitry EC2 can include at least two memories which are separately provided. The at least one control algorithm of the transmission device RD can be executed by the at least two processors if needed or desired. The at least one control algorithm of the transmission device RD can be stored in the at least two memories if needed or desired. The second controller circuitry EC2 can include at least two circuit boards which are separately provided if needed or desired. The second controller circuitry EC2 can include at least two system buses which are separately provided if needed or desired.

As seen in FIG. 3, the human-powered vehicle B includes an operating device 16. The operating device 16 is electrically connected to the transmission device RD via an electrical cable 17. Alternatively, the operating device 16 can be electrically connected to the transmission device RD wirelessly.

The operating device 16 is configured to receive a gear-shifting user input U21. The operating device 16 is configured to receive a gear-shifting user input U22. For example, the gear-shifting user input U21 is indicative of upshifting of the transmission device RD. The gear-shifting user input U22 is indicative of downshifting of the transmission device RD. The transmission device RD is configured to upshift in response to the gear-shifting user input U21. The transmission device RD is configured to downshift in response to the gear-shifting user input U22. The second controller circuitry EC2 of the transmission device RD is configured to control the electric actuator RD2 to move the chain guide RD6 in an upshifting direction in response to the gear-shifting user input U21. The second controller circuitry EC2 is configured to control the electric actuator RD2 to move the chain guide RD6 in a downshifting direction in response to the gear-shifting user input U22.

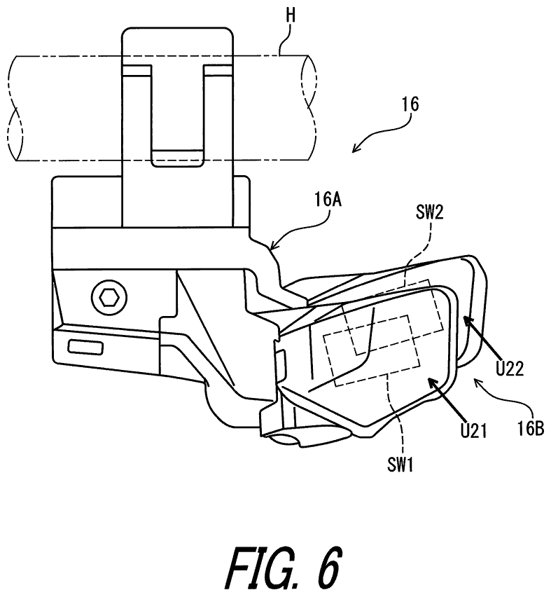

As seen in FIG. 6, the operating device 16 includes a housing 16A and a user interface 16B. The housing 16A is configured to be mounted to the vehicle body VB of the human-powered vehicle B. The user interface 16B is configured to be operated by the user to control the transmission device RD while the human-powered vehicle B is running.

The user interface 16B is configured to receive the gear-shifting user input U21. For example, the user interface 16B includes a switch SW21 configured to be activated in response to the gear-shifting user input U21.

The user interface 16B is configured to receive the gear-shifting user input U22. For example, the user interface 16B includes a switch SW22 configured to be activated in response to the gear-shifting user input U22.

As seen in FIG. 3, the operating device 16 comprises fourth controller circuitry EC4. The fourth controller circuitry EC4 is electrically connected to the user interface 16B to the gear-shifting user input U21 or U22 via the user interface 16B. The fourth controller circuitry EC4 is electrically connected to the switch SW21 to detect the activation of the switch SW21 caused by the gear-shifting user input U21. The fourth controller circuitry EC4 is electrically connected to the switch SW22 to detect the activation of the switch SW22 caused by the gear-shifting user input U22. The fourth controller circuitry EC4 is configured to generate a control signal CS21 in response to the gear-shifting user input U21. The fourth controller circuitry EC4 is configured to generate a control signal CS22 in response to the gear-shifting user input U22.

The fourth controller circuitry EC4 includes at least one processor EC41 and at least one memory EC42. The fourth controller circuitry EC4 includes at least one circuit board EC43 and at least one system bus EC44. The fourth controller circuitry EC4 is electrically mounted on the at least one circuit board EC43. The at least one processor EC41 and the at least one memory EC42 are electrically mounted on the at least one circuit board EC43. The at least one processor EC41 is coupled to the at least one memory EC42. The at least one memory EC42 is coupled to the at least one processor EC41. The at least one processor EC41 is electrically connected to the at least one memory EC42 via the at least one circuit board EC43 and the at least one system bus EC44. The at least one memory EC42 is electrically connected to the at least one processor EC41 via the at least one circuit board EC43 and the at least one system bus EC44. For example, the fourth controller circuitry EC4 includes at least one semiconductor. The at least one processor EC41 includes at least one semiconductor. The at least one memory EC42 includes at least one semiconductor.

For example, the at least one processor EC41 includes at least one of a central processing unit (CPU), a micro processing unit (MPU), a graphics processing unit (GPU), and a memory controller. The at least one memory EC42 is electrically connected to the at least one processor EC41. For example, the at least one memory EC42 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The at least one memory EC42 includes storage areas each having an address. The at least one processor EC41 is configured to control the at least one memory EC42 to store data in the storage areas of the at least one memory EC42 and reads data from the storage areas of the at least one memory EC42. The at least one processor EC41 can also be referred to as at least one hardware processor EC41, at least one processor circuit EC41, or processor circuitry EC41. The at least one memory EC42 can also be referred to as at least one hardware memory EC42, at least one memory circuit, or memory circuitry EC42. The at least one memory EC42 can also be referred to as a non-transitory computer-readable storage medium EC42. Namely, the fourth controller circuitry EC4 includes the non-transitory computer-readable storage medium EC42. The fourth controller circuitry EC4 can also be referred to as first electronic controller circuitry.

The fourth controller circuitry EC4 is configured to execute at least one control algorithm of the operating device 16. For example, the fourth controller circuitry EC4 is programed to execute at least one control algorithm of the operating device 16. The at least one memory EC42 stores at least one program including at least one computer program code. The at least one program is read into the at least one processor EC41, and thereby the at least one control algorithm of the operating device 16 is executed based on the at least one program.

The structure of the fourth controller circuitry EC4 is not limited to the above structure. The structure of the fourth controller circuitry EC4 is not limited to the at least one processor EC41 and the at least one memory EC42. The fourth controller circuitry EC4 can be realized by hardware alone, software alone, or a combination of hardware and software. In the present embodiment, the at least one processor EC41 and the at least one memory EC42 can be separate chips. Alternatively, the at least one processor EC41 and the at least one memory EC42 can be integrated as a single chip such as an application specific integrated circuit (ASIC) or a field programmable gate array (FPGA).

The fourth controller circuitry EC4 can include at least two electronic controller circuits which are separately provided. The at least one control algorithm of the operating device 16 can be executed by the at least two electronic controller circuits if needed or desired. The fourth controller circuitry EC4 can include at least two processors which are separately provided. The fourth controller circuitry EC4 can include at least two memories which are separately provided. The at least one control algorithm of the operating device 16 can be executed by the at least two processors if needed or desired. The at least one control algorithm of the operating device 16 can be stored in the at least two memories if needed or desired. The fourth controller circuitry EC4 can include at least two circuit boards which are separately provided if needed or desired. The fourth controller circuitry EC4 can include at least two system buses which are separately provided if needed or desired.

As seen in FIG. 1, the assist drive unit DU is configured to generate the assist torque TQ2 to assist the propulsion of the human-powered vehicle B. To assist propulsion of the human-powered vehicle B, the assist drive unit DU applies the assist torque TQ2 to the drivetrain DT depending on the pedaling torque TQ1 applied from the rider to the crank CR. Total driving torque TQ, which is a total of the pedaling torque TQ1 and the assist torque TQ2, is applied to the drivetrain DT when the assist drive unit DU applies the assist torque TQ2 to the drivetrain DT during pedaling. Tension corresponding to the total driving torque TQ is applied to the chain CH.

In a case where the total driving torque TQ is greater than specific torque, however, tension of the chain CH exceeds a certain level. The excessive tension of the chain CH makes the gear shifting difficult to be smoothly executed by the transmission device RD. Thus, the assist drive unit DU can be configured to cooperate with the transmission device RD such that the assist torque TQ2 is reduced during the gear shifting. In this case, the assist drive unit DU obtains information relating to the gear shifting from the transmission device RD. However, a communication protocol of the assist drive unit DU can be different from a communication protocol of the transmission device RD.

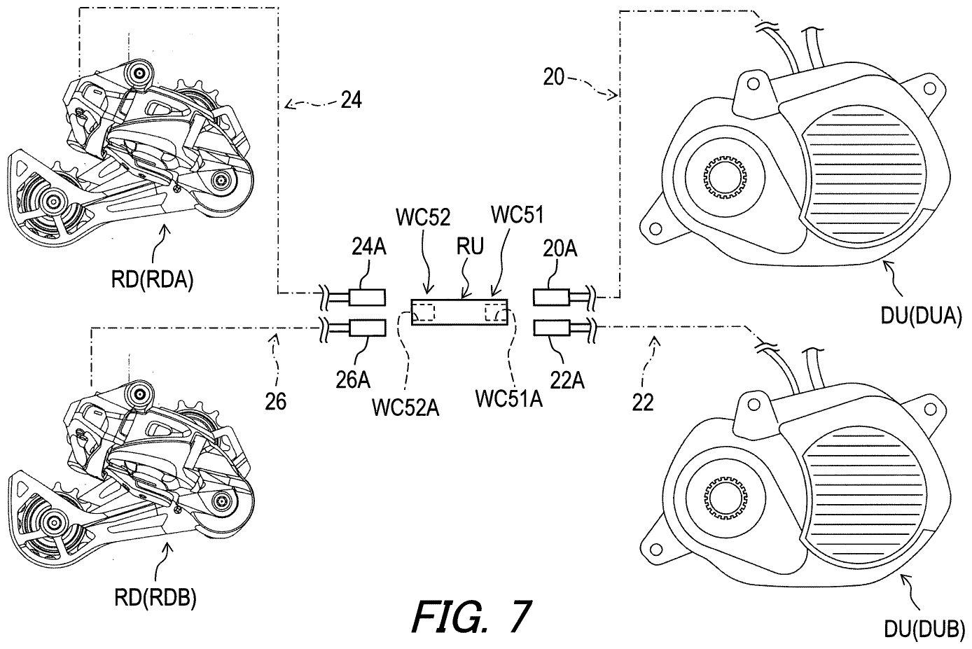

As seen in FIG. 7, for example, the human-powered vehicle B can be equipped, as the assist drive unit DU, with one of at least two different assist drive units. The human-powered vehicle B can be equipped, as the transmission device RD, with a transmission device one of at least two different transmission devices. For example, the human-powered vehicle B can be equipped, as the assist drive unit DU, with one of a first assist drive unit DUA and a second assist drive unit DUB. The human-powered vehicle B can be equipped, as the transmission device RD, with one of a first transmission device RDA and a second transmission device RDB.

The first assist drive unit DUA is configured to assist propulsion of the human-powered vehicle B. The second assist drive unit DUB is configured to assist propulsion of the human-powered vehicle B. The first assist drive unit DUA can be referred to as an assist drive unit DUA. The second assist drive unit DUB can be referred to as an assist drive unit DUB. Thus, the assist drive unit DUA is configured to assist propulsion of the human-powered vehicle B. The assist drive unit DUB is configured to assist propulsion of the human-powered vehicle B. The assist drive unit DUA is configured to generate the assist torque TQ2 (see e.g., FIG. 1) to assist the propulsion of the human-powered vehicle B. The assist drive unit DUB is configured to generate the assist torque TQ2 (see e.g., FIG. 1) to assist the propulsion of the human-powered vehicle B.

The second assist drive unit DUB is different from the first assist drive unit DUA. For example, identification information of the first assist drive unit DUA is different from identification information of the second assist drive unit DUB. A manufacturing company of the first assist drive unit DUA is different from a manufacturing company of the second assist drive unit DUB.

The first transmission device RDA is configured to execute the gear shifting of the human-powered vehicle B. The second transmission device RDB is configured to execute the gear shifting of the human-powered vehicle B. The first transmission device RDA can also be referred to as a transmission device RDA. The second transmission device RDB can also be referred to as a transmission device RDB. Thus, the transmission device RDA is configured to execute a gear shifting of the human-powered vehicle B. The transmission device RDB is configured to execute a gear shifting of the human-powered vehicle B.

The second transmission device RDB is different from the first transmission device RDA. For example, identification information of the first transmission device RDA is different from identification information of the second transmission device RDB. A manufacturing company of the first transmission device RDA is different from a manufacturing company of the second transmission device RDB.

The assist drive unit DU may be configured to use a communication protocol which is different from a communication protocol of the transmission device RD. For example, the assist drive unit DU can be configured to communicate with another device using a communication protocol such as Power Line Communication (PLC), Control Arca Network (CAN), or Local Interconnect Network (LIN). The transmission device RD can be configured to communicate with another device using a communication protocol such as PLC, CAN, or LIN. The assist drive unit DU can be configured to communicate with another device using CAN while the transmission device RD can be configured to communicate with another device using PLC.

In a case where a communication protocol of the assist drive unit DU is different from a communication protocol of the transmission device RD, the assist drive unit DU cannot obtain information relating to the gear shifting directly from the transmission device RD.

Thus, in the present embodiment, the human-powered vehicle system 10 comprises a relay unit RU. The assist drive unit DU is configured to be electrically connected to the relay unit RU. The transmission device RD is configured to be electrically connected to the relay unit RU. The relay unit RU is configured to electrically connect the assist drive unit DU and the transmission device RD. The assist drive unit DU is electrically connected to the transmission device RD via the relay unit RU in a state where the relay unit RU is electrically connected to the assist drive unit DU and the transmission device RD.

As seen in FIG. 3, the relay unit RU comprises interface circuitry WC5. The interface circuitry WC5 is configured to be electrically connected to at least one of the first assist drive unit DUA of the human-powered vehicle B and the transmission device RD of the human-powered vehicle B. The interface circuitry WC5 is configured to be electrically connected to the first assist drive unit DUA and the transmission device RD.

The interface circuitry WC5 is configured to be electrically connected to the second assist drive unit DUB instead of the first assist drive unit DUA. The interface circuitry WC5 is configured to be electrically connected to one of the first assist drive unit DUA and the second assist drive unit DUB selectively. The interface circuitry WC5 is configured to be electrically connected to at least one of the second assist drive unit DUB and the transmission device RD. The interface circuitry WC5 is configured to be electrically connected to the second assist drive unit DUB and the transmission device RD.

The interface circuitry WC5 includes first interface circuitry WC51 and second interface circuitry WC52. Namely, the relay unit RU comprises the first interface circuitry WC51 and the second interface circuitry WC52.

The first interface circuitry WC51 is configured to be electrically connected to the assist drive unit DU of the human-powered vehicle B. The first interface circuitry WC51 is configured to be electrically connected to the assist drive unit DUA of the human-powered vehicle B. The first interface circuitry WC51 is configured to be electrically connected to the assist drive unit DUB of the human-powered vehicle B. The first interface circuitry WC51 is configured to be electrically connected to one of the first assist drive unit DUA and the second assist drive unit DUB selectively.

As seen in FIG. 7, for example, the first interface circuitry WC51 is configured to be electrically connected to the assist drive unit DUA via an electrical cable 20. A connector 20A of the electrical cable 20 is detachably connectable to the first interface circuitry WC51. The first interface circuitry WC51 includes a first connector port WC51A. The connector 20A of the electrical cable 20 is detachably connectable to the first connector port WC51A.

The first interface circuitry WC51 is configured to be electrically connected to the assist drive unit DUB via an electrical cable 22. A connector 22A of the electrical cable 22 is detachably connectable to the first interface circuitry WC51. The connector 22A of the electrical cable 22 is detachably connectable to the first connector port WC51A.

The second interface circuitry WC52 is configured to be electrically connected to the transmission device RDA of the human-powered vehicle B. The second interface circuitry WC52 is configured to be electrically connected to the transmission device RDB of the human-powered vehicle B. The second interface circuitry WC52 is configured to be electrically connected to one of the first transmission device RDA and the second transmission device RDB selectively.

For example, the second interface circuitry WC52 is configured to be electrically connected to the transmission device RDA via an electrical cable 24. A connector 24A of the electrical cable 24 is detachably connectable to the second interface circuitry WC52. The second interface circuitry WC52 includes a second connector port WC52A. The connector 24A of the electrical cable 24 is detachably connectable to the second connector port WC52A.

The second interface circuitry WC52 is configured to be electrically connected to the transmission device RDB via an electrical cable 26. A connector 26A of the electrical cable 26 is detachably connectable to the second interface circuitry WC52. The connector 26A of the electrical cable 26 is detachably connectable to the second connector port WC52A.

As seen in FIG. 3, the relay unit RU comprises controller circuitry EC5. The controller circuitry EC5 is electrically connected to the interface circuitry WC5. The controller circuitry EC5 is electrically connected to the first interface circuitry WC51 and the second interface circuitry WC52. Thus, the controller circuitry EC5 is electrically connected to the assist drive unit DU and the transmission device RD via the first interface circuitry WC51 and the controller circuitry EC5, respectively.

The controller circuitry EC5 includes at least one processor EC51 and at least one memory EC52. The controller circuitry EC5 includes at least one circuit board EC53 and at least one system bus EC54. The controller circuitry EC5 is electrically mounted on the at least one circuit board EC53. The at least one processor EC51 and the at least one memory EC52 are electrically mounted on the at least one circuit board EC53. The at least one processor EC51 is coupled to the at least one memory EC52. The at least one memory EC52 is coupled to the at least one processor EC51. The at least one processor EC51 is electrically connected to the at least one memory EC52 via the at least one circuit board EC53 and the at least one system bus EC54. The at least one memory EC52 is electrically connected to the at least one processor EC51 via the at least one circuit board EC53 and the at least one system bus EC54. For example, the controller circuitry EC5 includes at least one semiconductor. The at least one processor EC51 includes at least one semiconductor. The at least one memory EC52 includes at least one semiconductor.

For example, the at least one processor EC51 includes at least one of a central processing unit (CPU), a micro processing unit (MPU), a graphics processing unit (GPU), and a memory controller. The at least one memory EC52 is electrically connected to the at least one processor EC51. For example, the at least one memory EC52 includes at least one of a volatile memory and a non-volatile memory. Examples of the volatile memory include a random-access memory (RAM) and a dynamic random-access memory (DRAM).

Examples of the non-volatile memory include a read only memory (ROM), an electrically erasable programmable ROM (EEPROM), and a magnetic disc. The at least one memory EC52 includes storage areas each having an address. The at least one processor EC51 is configured to control the at least one memory EC52 to store data in the storage areas of the at least one memory EC52 and reads data from the storage areas of the at least one memory EC52. The at least one processor EC51 can also be referred to as at least one hardware processor EC51, at least one processor circuit EC51, or processor circuitry EC51. The at least one memory EC52 can also be referred to as at least one hardware memory EC52, at least one memory circuit, or memory circuitry EC52. The at least one memory EC52 can also be referred to as a non-transitory computer-readable storage medium EC52. Namely, the controller circuitry EC5 includes the non-transitory computer-readable storage medium EC52.

The controller circuitry EC5 is configured to execute at least one control algorithm of the controller circuitry EC5. For example, the controller circuitry EC5 is programed to execute at least one control algorithm of the controller circuitry EC5. The at least one memory EC52 stores at least one program including at least one computer program code. The at least one program is read into the at least one processor EC51, and thereby the at least one control algorithm of the controller circuitry EC5 is executed based on the at least one program.

The structure of the controller circuitry EC5 is not limited to the above structure. The structure of the controller circuitry EC5 is not limited to the at least one processor EC51 and the at least one memory EC52. The controller circuitry EC5 can be realized by hardware alone, software alone, or a combination of hardware and software. In the present embodiment, the at least one processor EC51 and the at least one memory EC52 can be separate chips. Alternatively, the at least one processor EC51 and the at least one memory EC52 can be integrated as a single chip such as an application specific integrated circuit (ASIC) or a field programmable gate array (FPGA).

The controller circuitry EC5 can include at least two electronic controller circuits which are separately provided. The at least one control algorithm of the controller circuitry EC5 can be executed by the at least two electronic controller circuits if needed or desired. The controller circuitry EC5 can include at least two processors which are separately provided. The controller circuitry EC5 can include at least two memories which are separately provided. The at least one control algorithm of the controller circuitry EC5 can be executed by the at least two processors if needed or desired. The at least one control algorithm of the controller circuitry EC5 can be stored in the at least two memories if needed or desired. The controller circuitry EC5 can include at least two circuit boards which are separately provided if needed or desired. The controller circuitry EC5 can include at least two system buses which are separately provided if needed or desired.

As seen in FIG. 3, the first interface circuitry WC51 includes first wired communicator circuitry WC53. The first wired communicator circuitry WC53 is electrically connected to the controller circuitry EC5 and the first interface circuitry WC51. The first wired communicator circuitry WC53 is configured to communicate with another wired communicator circuitry. For example, the first wired communicator circuitry WC53 is configured to communicate with wired communicator circuitry of the assist drive unit DU via the electrical cable 20 or 22. The first wired communicator circuitry WC53 is configured to communicate with another wired communicator circuitry using a communication protocol such as CAN, LIN, or PLC. In the present embodiment, the first wired communicator circuitry WC53 is configured to communicate with another wired communicator circuitry using a communication protocol of CAN.

The second interface circuitry WC52 includes second wired communicator circuitry WC54. The second wired communicator circuitry WC54 is electrically connected to the controller circuitry EC5 and the second interface circuitry WC52. The second wired communicator circuitry WC54 is configured to communicate with another wired communicator circuitry. For example, the second wired communicator circuitry WC54 is configured to communicate with wired communicator circuitry of the transmission device RD via the electrical cable 24 or 26. The second wired communicator circuitry WC54 is configured to communicate with another wired communicator circuitry using a communication protocol such as CAN, LIN, or PLC. In the present embodiment, the second wired communicator circuitry WC54 is configured to communicate with another wired communicator circuitry using a communication protocol of PLC.

As seen in FIG. 3, the assist drive unit DU includes first additional interface circuitry WC1. The first additional interface circuitry WC1 is configured to be electrically connected to the first interface circuitry WC51 of the relay unit RU via the electrical cable 20 or 22. The first additional interface circuitry WC1 is electrically connected to the first controller circuitry EC1.

The first additional interface circuitry WC1 includes first additional wired communicator circuitry WC11. The first additional wired communicator circuitry WC11 is electrically connected to the electrical cable 20 or 22. The first additional wired communicator circuitry WC11 is configured to communicate with another wired communicator circuitry. For example, the first additional wired communicator circuitry WC11 is configured to communicate with the first wired communicator circuitry WC51A of the relay unit RU via the electrical cable 20 or 22. The first additional wired communicator circuitry WC11 is configured to communicate with another wired communicator circuitry using a communication protocol such as CAN, LIN, or PLC. In the present embodiment, the first additional wired communicator circuitry WC11 is configured to communicate with another wired communicator circuitry using a communication protocol of CAN.

As seen in FIG. 3, the transmission device RD includes second additional interface circuitry WC2. The second additional interface circuitry WC2 is configured to be electrically connected to the second interface circuitry WC52 of the relay unit RU via the electrical cable 24 or 26. The second additional interface circuitry WC2 is electrically connected to the second controller circuitry EC2.

The second additional interface circuitry WC2 includes second additional wired communicator circuitry WC21. The second additional wired communicator circuitry WC21 is electrically connected to the electrical cable 24 or 26. The second additional wired communicator circuitry WC21 is configured to communicate with another wired communicator circuitry. For example, the second additional wired communicator circuitry WC21 is configured to communicate with the second wired communicator circuitry WC52A of the relay unit RU via the electrical cable 24 or 26. The second additional wired communicator circuitry WC21 is configured to communicate with another wired communicator circuitry using a communication protocol such as CAN, LIN, or PLC. In the present embodiment, the second additional wired communicator circuitry WC21 is configured to communicate with another wired communicator circuitry using a communication protocol of PLC.

As seen in FIG. 3, the operating device 14 includes third interface circuitry WC3. The third interface circuitry WC3 is configured to be electrically connected to the first additional interface circuitry WC1 of the assist drive unit DU via the electrical cable 15. The third interface circuitry WC3 is electrically connected to the third controller circuitry EC3.

The third interface circuitry WC3 includes third wired communicator circuitry WC31. The third wired communicator circuitry WC31 is electrically connected to the electrical cable 15. The third wired communicator circuitry WC31 is configured to communicate with another wired communicator circuitry. For example, the third wired communicator circuitry WC31 is configured to communicate with first additional wired communicator circuitry WC11 of the assist drive unit DU via the electrical cable 15. The third wired communicator circuitry WC31 is configured to communicate with another wired communicator circuitry using a communication protocol such as CAN, LIN, or PLC. In the present embodiment, the third wired communicator circuitry WC31 is configured to communicate with another wired communicator circuitry using a communication protocol of PLC.

As seen in FIG. 3, the operating device 16 includes fourth interface circuitry WC4. The fourth interface circuitry WC4 is configured to be electrically connected to the second additional interface circuitry WC2 of the transmission device RD via the electrical cable 17. The fourth interface circuitry WC4 is electrically connected to the fourth controller circuitry EC4.

The fourth interface circuitry WC4 includes fourth wired communicator circuitry WC41. The fourth wired communicator circuitry WC41 is electrically connected to the electrical cable 17. The fourth wired communicator circuitry WC41 is configured to communicate with another wired communicator circuitry. For example, the fourth wired communicator circuitry WC41 is configured to communicate with second additional wired communicator circuitry WC21 of the transmission device RD via the electrical cable 17. The fourth wired communicator circuitry WC41 is configured to communicate with another wired communicator circuitry using a communication protocol such as CAN, LIN, or PLC. In the present embodiment, the fourth wired communicator circuitry WC41 is configured to communicate with another wired communicator circuitry using a communication protocol of PLC.

For example, the electrical cable 15, 17, 20, 22, 24, or 26 includes a ground line and a voltage line that are detachably connected to a serial bus that is formed by communication interfaces. The first wired communicator circuitry WC53, the second wired communicator circuitry WC54, the first additional wired communicator circuitry WC11, the second additional wired communicator circuitry WC21, the third wired communicator circuitry WC31, or the fourth wired communicator circuitry WC41 is configured to communicate with another wired communicator circuitry through the voltage line using the PLC, CAN, or LIN technology. Since the PLC, CAN, or LIN technology has been known, it will not be described in detail here for the sake of brevity.

As seen in FIG. 3, the assist drive unit DU is configured to be powered by the electric power source PS. The relay unit RU is configured to be electrically connected to the electric power source PS via the assist drive unit DU. The relay unit RU is configured to be powered by the electric power source PS via the assist drive unit DU. Alternatively, the relay unit RU can be powered by an electric power source other than the electric power source PS.

The transmission device RD is configured to be electrically connected to the electric power source PS via the relay unit RU and the assist drive unit DU. The transmission device RD is configured to be powered by the electric power source PS via the relay unit RU and the assist drive unit DU. Alternatively, the transmission device RD can be powered by an electric power source other than the electric power source PS.

The relay unit RU is configured to establish communication with the assist drive unit DU when electrical connection is established between the relay unit RU and the assist drive unit DU via the electrical cable 20 or 22. For example, the controller circuitry EC5 of the relay unit RU is configured to transmit, to the first controller circuitry EC1 of the assist drive unit DU, first communication information which is necessary to establish communication between the assist drive unit DU and the relay unit RU via the first interface circuitry WC51, the electrical cable 20 or 22, and the first additional interface circuitry WC1. The first controller circuitry EC1 of the assist drive unit DU is configured to transmit, to the controller circuitry EC5 of the relay unit RU, first additional communication information which is necessary to establish communication between the assist drive unit DU and the relay unit RU via the first additional interface circuitry WC1, the electrical cable 20 or 22, and the first interface circuitry WC51.

The first communication information includes the communication protocol of the relay unit RU. The first additional communication information includes the communication protocol of the assist drive unit DU. For example, the relay unit RU is configured to select the communication protocol which is the same as the communication protocol of the assist drive unit DU based on the first additional communication information.

The relay unit RU is configured to establish communication with the transmission device RD when electrical connection is established between the relay unit RU and the transmission device RD via the electrical cable 24 or 26. For example, the controller circuitry EC5 of the relay unit RU is configured to transmit, to the second controller circuitry EC2 of the transmission device RD, second communication information which is necessary to establish communication between the transmission device RD and the relay unit RU via the second interface circuitry WC52, the electrical cable 24 or 26, and the second additional interface circuitry WC2. The second controller circuitry EC2 of the transmission device RD is configured to transmit, to the controller circuitry EC5 of the relay unit RU, second additional communication information which is necessary to establish communication between the transmission device RD and the relay unit RU via the second additional interface circuitry WC2, the electrical cable 24 or 26, and the second interface circuitry WC52.

The second communication information includes the communication protocol of the relay unit RU. The second additional communication information includes the communication protocol of the transmission device RD. For example, the relay unit RU is configured to select the communication protocol which is the same as the communication protocol of the transmission device RD based on the second additional communication information.

After establishing communication between the relay unit RU and the assist drive unit DU, the first controller circuitry EC1 of the assist drive unit DU is configured to transmit identification information of the assist drive unit DU via the first additional interface circuitry WC1 and the first interface circuitry WC51. The controller circuitry EC5 of the relay unit RU is configured to receive the identification information of the assist drive unit DU from the assist drive unit DU via the first additional interface circuitry WC1 and the first interface circuitry WC51. The controller circuitry EC5 is configured to transmit identification information of the relay unit RU via the first interface circuitry WC51 and the first additional interface circuitry WC1. The first controller circuitry EC1 is configured to receive the identification information of the relay unit RU from the relay unit RU via the first interface circuitry WC51 and the first additional interface circuitry WC1.

The identification information of the assist drive unit DU includes a manufacturing company of the assist drive unit DU and a model number of the assist drive unit DU. The controller circuitry EC5 is configured to store assist data including at least one manufacturing company. Each of the at least one manufacturing company has at least one model number. The assist data includes the at least one mode number associated with corresponding one of the at least one manufacturing company. The assist data can include at least one communication time lag occurring between the assist drive unit DU and the relay unit RU. Each of the at least one communication time lag is associated with a combination of one of the at least one manufacturing company and corresponding one of the at least one model number. The controller circuitry EC5 is configured to select the communication time lag T1 corresponding to the identification information of the assist drive unit DU received from the assist drive unit DU. Alternatively, the assist drive unit DU can be configured to transmit the identification information including the communication time lag T1 to the relay unit RU.

The identification information of the relay unit RU includes a manufacturing company of the relay unit RU and a model number of the relay unit RU. The first controller circuitry EC1 is configured to store relay-unit data including at least one manufacturing company. Each of the at least one manufacturing company has at least one model number. The relay-unit data includes the at least one mode number associated with corresponding one of the at least one manufacturing company. The relay-unit data can include at least one parameter. Each of the at least one parameter is associated with a combination of one of the at least one manufacturing company and corresponding one of the at least one model number. The first controller circuitry EC1 is configured to select the parameter corresponding to the identification information of the relay unit RU received from the relay unit RU. Alternatively, the relay unit RU can be configured to transmit the identification information including the parameter to the relay unit RU.

After establishing communication between the relay unit RU and the transmission device RD, the second controller circuitry EC2 of the transmission device RD is configured to transmit identification information of the transmission device RD via the second additional interface circuitry WC2 and the second interface circuitry WC52. The controller circuitry EC5 of the relay unit RU is configured to receive the identification information of the transmission device RD from the transmission device RD via the second additional interface circuitry WC2 and the second interface circuitry WC52. The controller circuitry EC5 is configured to transmit identification information of the relay unit RU via the second interface circuitry WC52 and the second additional interface circuitry WC2. The second controller circuitry EC2 is configured to receive the identification information of the relay unit RU from the relay unit RU via the second interface circuitry WC52 and the second additional interface circuitry WC2.

The identification information of the transmission device RD includes a manufacturing company of the transmission device RD and a model number of the transmission device RD. The controller circuitry EC5 is configured to store assist data including at least one manufacturing company. Each of the at least one manufacturing company has at least one model number. The assist data includes the at least one mode number related to corresponding one of the at least one manufacturing company. The assist data can include at least one total number of gear stages and at least one gear-shifting time which is necessary to complete the gear shifting between adjacent two gear stages. Each of the at least one total number of gear stages is related to a combination of one of the at least one manufacturing company and corresponding one of the at least one model number. Each of the at least one gear-shifting time is related to a combination of one of the at least one manufacturing company and corresponding one of the at least one model number. The controller circuitry EC5 is configured to select the total number of gear stages corresponding to the identification information of the transmission device RD received from the transmission device RD. The controller circuitry EC5 is configured to select the gear-shifting time T2 corresponding to the identification information of the transmission device RD received from the transmission device RD. Alternatively, the transmission device RD can be configured to transmit the identification information including the gear-shifting time T2 to the relay unit RU.

The identification information of the relay unit RU includes a manufacturing company of the relay unit RU and a model number of the relay unit RU. The second controller circuitry EC2 is configured to store relay-unit data including at least one manufacturing company. Each of the at least one manufacturing company has at least one model number. The relay-unit data includes the at least one mode number related to corresponding one of the at least one manufacturing company. The relay-unit data can include at least one parameter. Each of the at least one parameter is related to a combination of one of the at least one manufacturing company and corresponding one of the at least one model number. The second controller circuitry EC2 is configured to select the parameter corresponding to the identification information of the relay unit RU received from the relay unit RU. Alternatively, the relay unit RU can be configured to transmit the identification information including the parameter to the relay unit RU.

As seen in FIG. 3, the first controller circuitry EC1 is configured to transmit the information INF1 to the relay unit RU via the first additional interface circuitry WC1 using a first communication protocol. The controller circuitry EC5 is configured to receive the information INF1 from the assist drive unit DU via the first interface circuitry WC51 using the first communication protocol.

The second controller circuitry EC2 is configured to transmit gear-shifting information INF2 to the relay unit RU via the second additional interface circuitry WC2 using a second communication protocol. The controller circuitry EC5 is configured to receive gear-shifting information INF2 from the transmission device RD via the second interface circuitry WC52. The controller circuitry EC5 is configured to receive the gear-shifting information INF2 from the transmission device RD via the second interface circuitry WC52 using the second communication protocol. The gear-shifting information INF2 relates to the gear shifting of the transmission device RD.

The second communication protocol is different from the first communication protocol. For example, the first communication protocol is the communication protocol of CAN. The second communication protocol is the communication protocol of PLC.

As seen in FIG. 3, the controller circuitry EC5 is configured to receive the information INF1 relating to the human-powered vehicle B from the sensor SS configured to detect the information INF1. The controller circuitry EC5 is configured to be electrically connected to the sensor SS. The controller circuitry EC5 is electrically connected to the interface circuitry WC5 and the sensor SS. The controller circuitry EC5 is configured to be electrically connected to the sensor SS via the first interface circuitry WC51, the electrical cable 20, the first additional interface circuitry WC1, and the first controller circuitry EC1. The controller circuitry EC5 is configured to receive the information INF1 from the sensor SS via the first controller circuitry EC1. For example, the controller circuitry EC5 is configured to receive the information INF1 generated by the first controller circuitry EC1 of the assist drive unit DU based on the output of the sensor SS.

The controller circuitry EC5 is configured to receive, from the sensor SS, the crank information INF11 relating to at least one of: the pedaling torque TQ1 applied to the crank CR; and the rotational position of the crank CR. The controller circuitry EC5 is configured to receive, from the sensor SS, the crank information INF11 relating to the pedaling torque TQ1 applied to the crank CR and the rotational position of the crank CR. The controller circuitry EC5 is configured to receive the crank information INF11 from the sensor SS via the first controller circuitry EC1. For example, the controller circuitry EC5 is configured to receive the crank information INF11 generated by the first controller circuitry EC1 of the assist drive unit DU based on the output of the sensor SS.

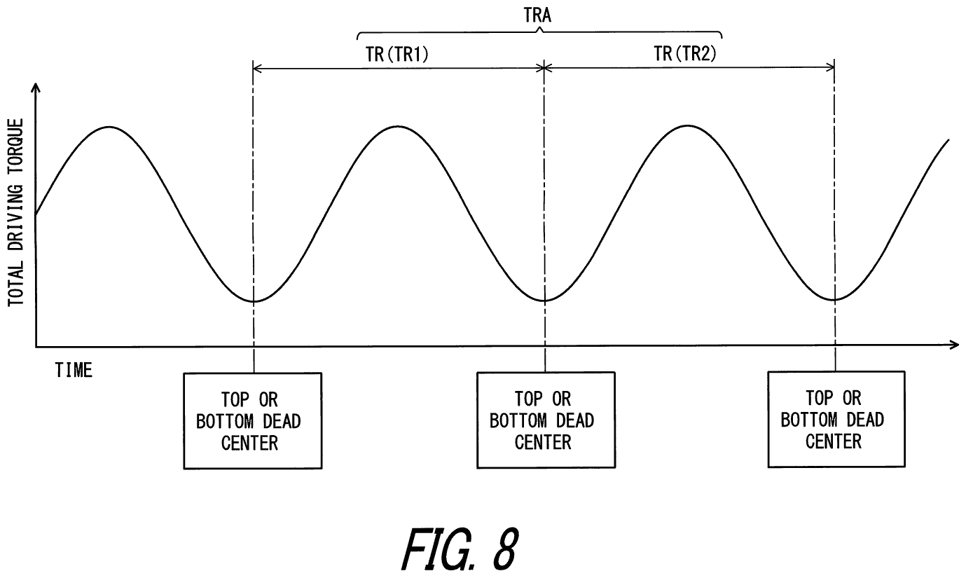

The first controller circuitry EC1 is configured to periodically receive the pedaling torque TQ1 detected by the force sensor SS1. The first controller circuitry EC1 is configured to recognize a change in the pedaling torque TQ1 detected by the force sensor SS1. For example, the first controller circuitry EC1 is configured to recognize at least one of a top dead center and a bottom dead center of the crank CR based on the change in the pedaling torque TQ1 detected by the force sensor SS1. For example, the change in the pedaling torque TQ1 can be expressed by a sine wave depicted in FIG. 8.

For example, the top dead center is a position in which the pedaling torque TQ1 becomes minimum. The bottom dead center is a position in which the pedaling torque TQ1 becomes minimum. The top dead center can be a position in which the total driving torque TQ becomes minimum since the total driving torque TQ changes in the same manner as the pedaling torque TQ1. Similarly, the bottom dead center can be a position in which the total driving torque TQ becomes minimum. In other words, the top dead center is a position in which one of the pedals PD1 and PD2 coupled to one of the crank arms CR1 and CR2 is in the highest position. The bottom dead center is a position in which one of the pedals PD1 and PD2 coupled to one of the crank arms CR1 and CR2 is in the lowest position. Alternatively, the first controller circuitry EC1 can be configured to recognize at least one of the top dead center and the bottom dead center based on the rotational position or the first to third acceleration detected by the position sensor SS2 of the sensor SS.

As seen in FIG. 8, the first controller circuitry EC1 of the assist drive unit DU is configured to obtain a crank rotation time TR of the crank CR. The crank rotation time TR is defined as the amount of time it takes for the crank CR to complete one full rotation about its rotational axis. For example, the first controller circuitry EC1 is configured to obtain the crank rotation time TR defined between adjacent two timings at which the crank CR is in the bottom dead center. The first controller circuitry EC1 is configured to measure the crank rotation time TR. The first controller circuitry EC1 is configured to store the latest two or more crank rotation times such as the crank rotation times TR1 and TR2. The first controller circuitry EC1 is configured to calculate an average of the latest two or more crank rotation times and is configured to store the average as an average crank rotation time TRA. For example, the first controller circuitry EC1 is configured to calculate an average of the crank rotation times TR1 and TR2 as the average crank rotation time TRA.

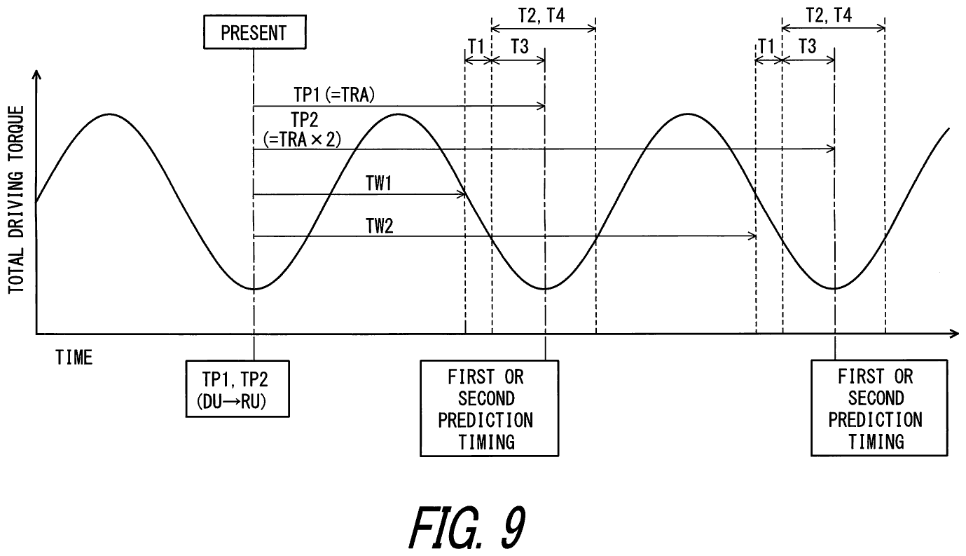

As seen in FIG. 9, the first controller circuitry EC1 is configured to predict at least one of: a first prediction timing at which the pedaling torque TQ1 becomes minimum; and a second prediction timing at which the crank arm CR1 or CR2 of the crank CR is positioned in one of the top dead center and the bottom dead center. The first controller circuitry EC1 is configured to predict at least one of the first prediction timing and the second prediction timing based on the average crank rotation time TRA. The pedaling torque TQ1 becomes minimum when one of the crank arms CR1 and CR2 is positioned in one of the top dead center and the bottom dead center. Thus, the first prediction timing can be the same as the second prediction timing.

For example, the first controller circuitry EC1 is configured to obtain a first prediction time TP1 and a second prediction time TP2 based on the average crank rotation time TRA when the pedaling torque TQ1 is minimum or when the crank arm CR1 or CR2 of the crank CR is in the bottom dead center. The first controller circuitry EC1 is configured to calculate the first prediction time TP1 which is equal to the average crank rotation time TRA when the pedaling torque TQ1 is minimum or when the crank arm CR1 or CR2 of the crank CR is in the bottom dead center. The first controller circuitry EC1 is configured to calculate the second prediction time TP2 which is equal to twice as much as the average crank rotation time TRA when the pedaling torque TQ1 is minimum or when the crank arm CR1 or CR2 of the crank CR is in the bottom dead center. The first controller circuitry EC1 is configured to store the first prediction time TP1 and the second prediction time TP2 in the memory EC12.

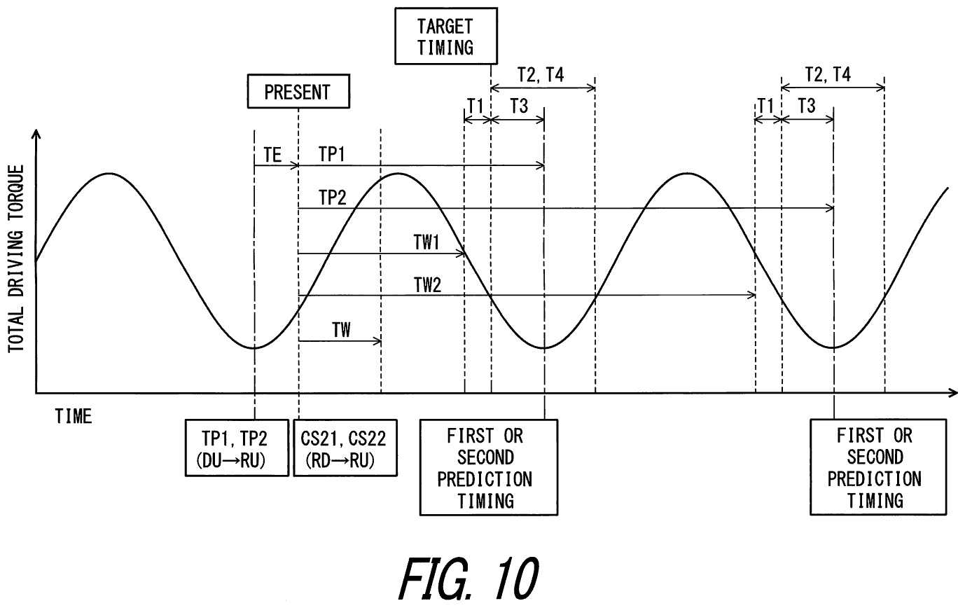

As seen in FIG. 10, the first controller circuitry EC1 is configured to measure an elapsed time TE which elapses from the latest timing at which the pedaling torque TQ1 is minimum or at which the crank arm CR1 or CR2 of the crank CR is in the bottom dead center. The first controller circuitry EC1 is configured to update the first prediction time TP1 and the second prediction time TP2 based on the elapsed time TE. For example, the first controller circuitry EC1 is configured to subtract the elapsed time TE from the first prediction time TP1 to update the first prediction time TP1. The first controller circuitry EC1 is configured to subtract the elapsed time TE from the second prediction time TP2 to update the second prediction time TP2.

The first controller circuitry EC1 is configured to newly obtain the first prediction time TP1 and the second prediction time TP2 based on the average crank rotation time TRA when the pedaling torque TQ1 is minimum or when the crank arm CR1 or CR2 of the crank CR is in the bottom dead center. The first controller circuitry EC1 is configured to periodically update the first prediction time TP1 and the second prediction time TP2 based on the elapsed time TE. Thus, the first controller circuitry EC1 is configured to periodically recognize the first prediction time TP1 and the second prediction time TP2. The total number of prediction times is not limited to two. The first controller circuitry EC1 can be configured to periodically recognize the first prediction time TP1, the second prediction time TP2, and at least one additional prediction time.

The first controller circuitry EC1 is configured to transmit the first prediction time TP1 and the second prediction time TP2 to the relay unit RU via the first additional interface circuitry WC1. The first controller circuitry EC1 is configured to transmit the first prediction time TP1 and the second prediction time TP2 to the relay unit RU via the first additional interface circuitry WC1 when the crank arm CR1 or CR2 of the crank CR is at one or more predetermined angles defined relative to the top dead center. For example, the first controller circuitry EC1 is configured to transmit the first prediction time TP1 and the second prediction time TP2 to the relay unit RU via the first additional interface circuitry WC1 when the crank arm CR1 or CR2 of the crank CR is at 45 degrees, 90 degrees (e.g., the bottom dead center), 135 degrees, and 180 degrees (e.g., the top dead center). Alternatively, the first controller circuitry EC1 can be configured to transmit the first prediction time TP1 and the second prediction time TP2 to the relay unit RU via the first additional interface circuitry WC1 periodically regardless of the rotational position of the crank CR.

As seen in FIG. 1, the crank information INF11 relates to at least one of: the first prediction timing at which the pedaling torque TQ1 becomes minimum; and the second prediction timing at which the crank arm CR1 or CR2 of the crank CR is positioned in one of the top dead center and the bottom dead center. For example, the crank information INF11 includes the first prediction timing, the second prediction timing, the first prediction time TP1, and the second prediction time TP2.

The first controller circuitry EC1 of the assist drive unit DU is configured to transmit the crank information INF11, which includes the first prediction time TP1 and the second prediction time TP2, to the relay unit RU via the first additional interface circuitry WC1. The controller circuitry EC5 of the relay unit RU is configured to receive the crank information INF11, which includes the first prediction time TP1 and the second prediction time TP2, from the assist drive unit DU via the first interface circuitry WC51. The controller circuitry EC5 is configured to store the first prediction time TP1 and the second prediction time TP2 in the memory EC52.

As seen in FIG. 1, the second controller circuitry EC2 of the transmission device RD is configured to receive the control signal CS21 or CS22 from the operating device 16 via the second additional interface circuitry WC2. The second controller circuitry EC2 is configured to transmit, without controlling the electric actuator RD2, the control signal CS21 or CS22 to the relay unit RU via the second additional interface circuitry WC2 when receiving the control signal CS21 or CS22 from the operating device 16. The second controller circuitry EC2 is configured to wait for a gear-shifting signal transmitted from the relay unit RU after transmitting the control signal CS21 or CS22 to the relay unit RU.

The controller circuitry EC5 of the relay unit RU is configured to receive the control signal CS21 or CS22 from the transmission device RD via the second interface circuitry WC52. The controller circuitry EC5 is configured to generate a gear-shifting signal CS41 based on the control signal CS21. The controller circuitry EC5 is configured to generate a gear-shifting signal CS42 based on the control signal CS22. For example, the gear-shifting signal CS41 is indicative of upshifting of the transmission device RD. The gear-shifting signal CS42 is indicative of downshifting of the transmission device RD. The controller circuitry EC5 is configured to transmit the gear-shifting signal CS41 or CS42 to the transmission device RD via the second interface circuitry WC52.

The second controller circuitry EC2 of the transmission device RD is configured to receive the gear-shifting signal CS41 or CS42 from the relay unit RU via the second additional interface circuitry WC2. The second controller circuitry EC2 is configured to execute the gear shifting in response to the gear-shifting signal CS41 or CS42. For example, the second controller circuitry EC2 is configured to control the electric actuator RD2 to move the chain guide RD6 of the movable structure RD4 in an upshifting direction in response to the gear-shifting signal CS41. The second controller circuitry EC2 of the transmission device RD is configured to control the electric actuator RD2 to move the chain guide RD6 of the movable structure RD4 in a downshifting direction in response to the gear-shifting signal CS42.

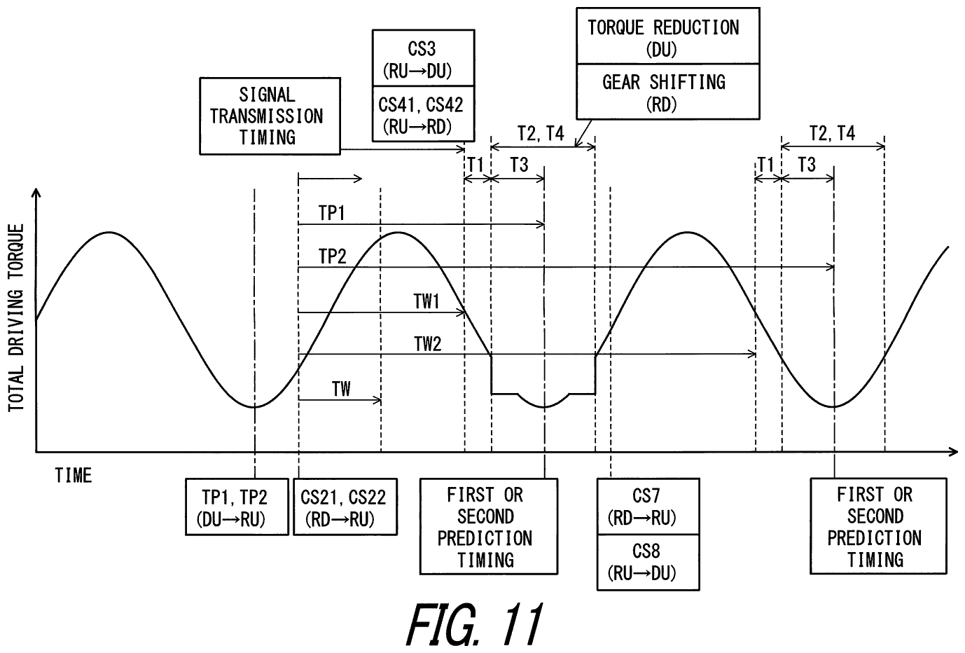

As seen in FIG. 11, the controller circuitry EC5 is configured to change a timing of the gear shifting of the transmission device RD based on the information INF1. The controller circuitry EC5 is configured to change the timing of the gear shifting based on the crank information INF11. The controller circuitry EC5 is configured to change the timing of the gear shifting based on the at least one of the pedaling torque TQ1 and the rotational position. The controller circuitry EC5 is configured to change the timing of the gear shifting based on the at least one of the first prediction timing and the second prediction timing. The controller circuitry EC5 is configured to change the timing of the gear shifting based on the first prediction time TP1 and the second prediction time TP2.

The controller circuitry EC5 is configured to change the timing of the gear shifting to a target timing at which the pedaling torque TQ1 applied to the crank CR of the human-powered vehicle B is lower than a pedaling torque threshold. The controller circuitry EC5 is configured to change the timing of the gear shifting to the target timing at which the crank CR is positioned near the bottom dead center of the crank CR.

The controller circuitry EC5 is configured to calculate the target timing of the gear shifting based on the information INF1. The controller circuitry EC5 is configured to calculate the target timing of the gear shifting based on the crank information INF11. The controller circuitry EC5 is configured to calculate the target timing of the gear shifting based on one of the first prediction time TP1 and the second prediction time TP2 transmitted from the assist drive unit DU.

As seen in FIG. 1, the controller circuitry EC5 is configured to transmit, to the transmission device RD via the second interface circuitry WC52 based on the information INF1, the gear-shifting signal CS41 or CS42 such that the transmission device RD executes the gear shifting at the target timing calculated by the controller circuitry EC5. The controller circuitry EC5 is configured to transmit, to the transmission device RD via the second interface circuitry WC52 based on the crank information INF11, the gear-shifting signal CS41 or CS42 such that the transmission device RD executes the gear shifting at the target timing calculated by the controller circuitry EC5. The controller circuitry EC5 is configured to transmit, to the transmission device RD via the second interface circuitry WC52 based on at least one of the first prediction time TP1 and the second prediction time TP2, the gear-shifting signal CS41 or CS42 such that the transmission device RD executes the gear shifting at the target timing calculated by the controller circuitry EC5.

The controller circuitry EC5 is configured to transmit, to the assist drive unit DU via the first interface circuitry WC51 based on the information INF1, a torque control signal CS3 such that the assist drive unit DU changes the assist torque TQ2. The controller circuitry EC5 is configured to transmit, to the assist drive unit DU via the first interface circuitry WC51 based on the crank information INF11, the torque control signal CS3 such that the assist drive unit DU changes the assist torque TQ2. The controller circuitry EC5 is configured to transmit, to the assist drive unit DU via the first interface circuitry WC51 based on the first prediction time TP1, the torque control signal CS3 such that the assist drive unit DU changes the assist torque TQ2.

The controller circuitry EC5 is configured to transmit, to the assist drive unit DU via the first interface circuitry WC51 based on the information INF1, the torque control signal CS3 such that the assist drive unit DU reduces the assist torque TQ2. The controller circuitry EC5 is configured to transmit, to the assist drive unit DU via the first interface circuitry WC51 based on the crank information INF11, the torque control signal CS3 such that the assist drive unit DU reduces the assist torque TQ2. The controller circuitry EC5 is configured to transmit, to the assist drive unit DU via the first interface circuitry WC51 based on the first prediction time TP1, the torque control signal CS3 such that the assist drive unit DU reduces the assist torque TQ2.

The assist drive unit DU is configured to limit the assist torque TQ2 to an upper limit in a case where the assist torque TQ2 reaches the upper limit. The assist drive unit DU is configured not to limit the assist torque TQ2 in a case where the assist torque TQ2 is lower than the upper limit. The first controller circuitry EC1 is configured to control the electric actuator DU2 via the actuator driver DU3 to limit the assist torque TQ2 to the upper limit in a case where the assist torque TQ2 reaches the upper limit. The first controller circuitry EC1 is configured to control the electric actuator DU2 via the actuator driver DU3 such that the assist torque TQ2 does not exceed the upper limit. The first controller circuitry EC1 is configured to store the upper limit in the memory EC12. The assist drive unit DU can be configured to limit the assist torque TQ2 by changing the assist ratio.

The controller circuitry EC5 is configured to transmit, to the assist drive unit DU via the first interface circuitry WC51 based on the information INF1, the torque control signal CS3 such that the assist drive unit DU reduces the upper limit. The controller circuitry EC5 is configured to transmit, to the assist drive unit DU via the first interface circuitry WC51 based on the crank information INF11, the torque control signal CS3 such that the assist drive unit DU reduces the upper limit. The controller circuitry EC5 is configured to transmit, to the assist drive unit DU via the first interface circuitry WC51 based on the first prediction time TP1, the torque control signal CS3 such that the assist drive unit DU reduces the upper limit.

The first controller circuitry EC1 of the assist drive unit DU is configured to receive the torque control signal CS3 from the relay unit RU. The first controller circuitry EC1 of the assist drive unit DU is configured to store a temporary upper limit. The temporary upper limit is lower than the upper limit. The first controller circuitry EC1 is configured to select the temporary upper limit for a torque reduction time T4 (see e.g., FIG. 11) in a case where the first controller circuitry EC1 receives the torque control signal CS3. The first controller circuitry EC1 is configured to select the upper limit after the torque reduction time T4 elapses. Thus, the assist drive unit DU temporarily reduces the upper limit to the temporary upper limit for the torque reduction time T4 in response to the torque control signal CS3. The first controller circuitry EC1 controls the electric actuator DU2 via the actuator driver DU3 to limit the assist torque TQ2 to the temporary upper limit for the torque reduction time T4 in a case where the first controller circuitry EC1 receives the torque control signal CS3 and where the assist torque TQ2 reaches the temporary upper limit.

Alternatively, the controller circuitry EC5 can be configured to transmit the torque control signal CS3 including the temporary upper limit to the assist drive unit DU via the first interface circuitry WC51 based on the information INF1. The controller circuitry EC5 can be configured to transmit the torque control signal CS3 including the temporary upper limit to the assist drive unit DU via the first interface circuitry WC51 based on the crank information INF11. The first controller circuitry EC1 can be configured to select the temporary upper limit included in the torque control signal CS3 for the torque reduction time T4 in a case where the first controller circuitry EC1 receives the torque control signal CS3.

The torque control signal CS3 can include the torque reduction time T4. The relay unit RU can be configured to transmit the torque control signal CS3 including the torque reduction time T4 to the assist drive unit DU based on the information INF1. The relay unit RU can be configured to transmit the torque reduction time T4 to the assist drive unit DU when the relay unit RU is electrically connected to the assist drive unit DU.

For example, the torque reduction time T4 is the same as the gear-shifting time T2 of the transmission device RD. Thus, the controller circuitry EC5 is configured to use the gear-shifting time T2 as the torque reduction time T4. Alternatively, the controller circuitry EC5 can be configured to calculate the torque reduction time T4 based on the gear-shifting time T2.

The controller circuitry EC5 is configured to change the timing of the gear shifting of the transmission device RD based on the information INF1 and the gear-shifting information INF2. The controller circuitry EC5 is configured to calculate, based on the information INF1, a signal transmission timing at which the controller circuitry EC5 transmits the gear-shifting signal CS41 or CS42 to the transmission device RD via the second interface circuitry WC52.

For example, the controller circuitry EC5 is configured to calculate a time T3 which is a half of the gear-shifting time T2. The controller circuitry EC5 is configured to calculate a first waiting time TW1 (see e.g., FIG. 11) based on the following equation (1) using the first prediction time TP1.

$$TW 1 = T P 1 - ( T 1 + T 3 ) \qquad ( 1 )$$

The controller circuitry EC5 is configured to calculate a second waiting time TW2 (see e.g., FIG. 11) based on the following equation (2) using the second prediction time TP2.

$$TW 2 = T P 2 - ( T 1 + T 3 ) \qquad ( 2 )$$

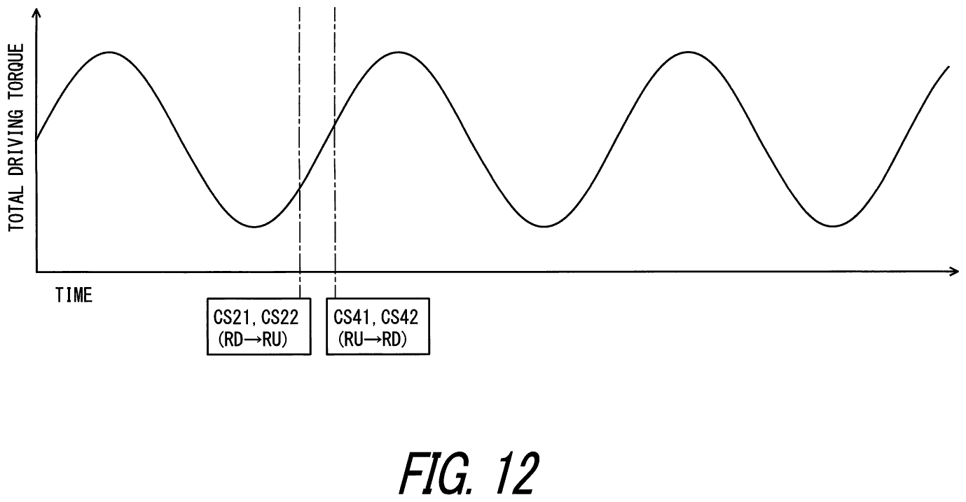

In a comparative example depicted in FIG. 12, the controller circuitry EC5 immediately transmits the gear-shifting signal CS41 or CS42 in response to the control signal CS21 or CS22 without using the first waiting time TW1 and the second waiting time TW2. In this case, the transmission device RD may execute the gear shifting while the total driving torque TQ is high. This may make the gear shifting difficult to be smoothly executed.

As seen in FIG. 11, to change the timing of the gear shifting of the transmission device RD, the controller circuitry EC5 is configured to transmit the gear-shifting signal CS41 or CS42 to the transmission device RD via the second interface circuitry WC52 when the first waiting time TW1 elapses in a case where the first waiting time TW1 is greater than or equal to a waiting time threshold TW. The controller circuitry EC5 is configured to transmit the gear-shifting signal CS41 or CS42 to the transmission device RD via the second interface circuitry WC52 when the second waiting time TW2 elapses in a case where the first waiting time TW1 is less than the waiting time threshold TW.

The controller circuitry EC5 is configured to transmit the torque control signal CS3 to the assist drive unit DU via the first interface circuitry WC51 when the first waiting time TW1 elapses in a case where the first waiting time TW1 is greater than or equal to a waiting time threshold TW. The controller circuitry EC5 is configured to transmit the torque control signal CS3 to the assist drive unit DU via the first interface circuitry WC51 when the second waiting time TW2 elapses in a case where the first waiting time TW1 is less than the waiting time threshold TW.

In the present embodiment, the controller circuitry EC5 is configured to transmit the gear-shifting signal CS41 or CS42 to the transmission device RD after transmitting the torque control signal CS3 to the assist drive unit DU. Alternatively, the controller circuitry EC5 can be configured to transmit the gear-shifting signal CS41 or CS42 to the transmission device RD at the same timing as the transmission of the torque control signal CS3 or before transmitting the torque control signal CS3 to the assist drive unit DU.

The first controller circuitry EC1 of the assist drive unit DU is configured to control, in response to the torque control signal CS3, the electric actuator DU2 via the actuator driver DU3 to limit the assist torque TQ2 to the temporary upper limit for the torque reduction time T4. The second controller circuitry EC2 of the transmission device RD is configured to control the electric actuator RD2 via the actuator driver RD3 to move the movable structure RD4 in the upshifting or downshifting direction in response to the gear-shifting signal CS41 or CS42. Thus, the gear shifting is executed by the transmission device RD while the assist torque TQ2 is maintained under the temporary upper limit which is lower than the upper limit. This can smoothen the gear shifting.

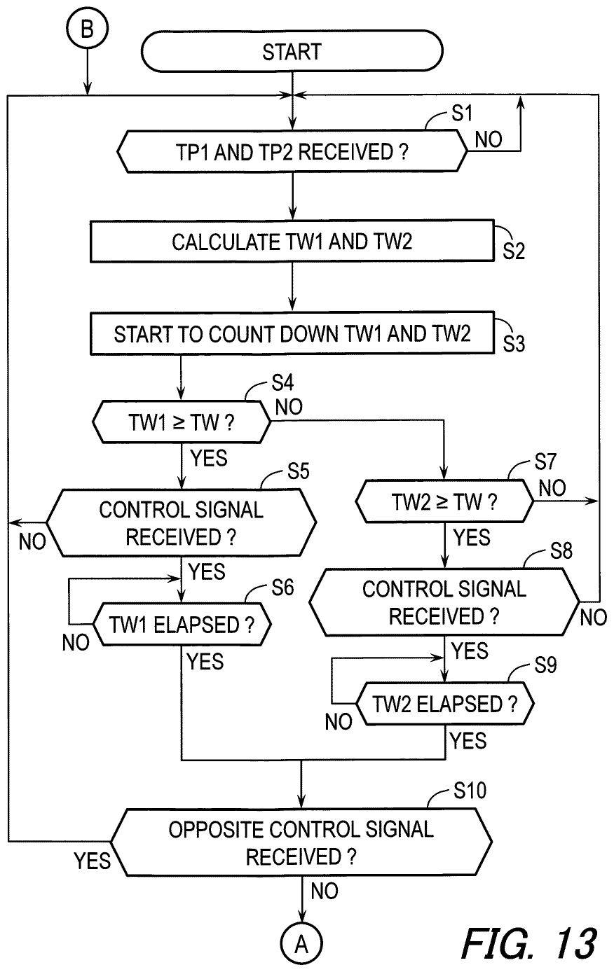

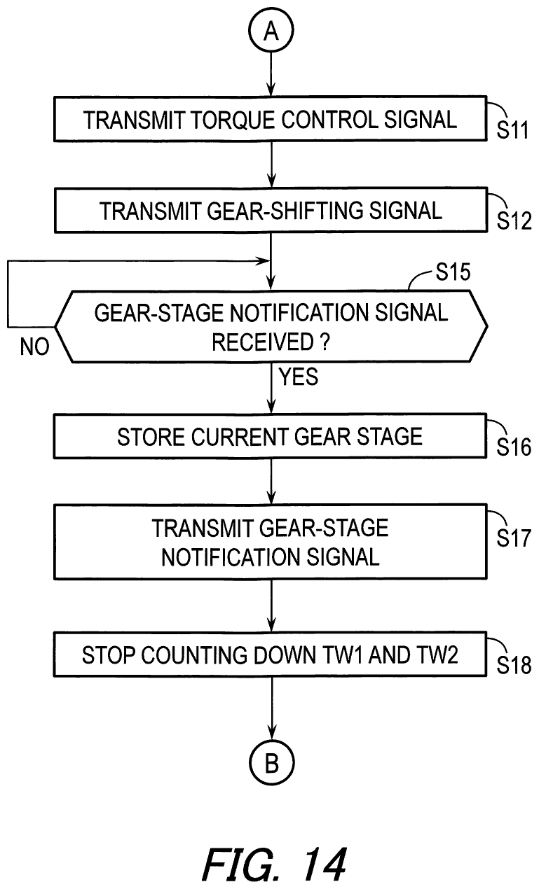

The control of the human-powered vehicle system 10 will be described in detail below referring to FIGS. 13 and 14.

As seen in FIG. 13, in steps S1 and S2, in a case where the controller circuitry EC5 receives the first prediction time TP1 and the second prediction time TP2 from the assist drive unit DU via the first interface circuitry WC51, the controller circuitry EC5 calculates the first waiting time TW1 using the first prediction time TP1 and the equation (1) and calculates the second waiting time TW2 using the second prediction time TP2 and the equation (2). In step S3, the controller circuitry EC5 starts to count down the first waiting time TW1 and the second waiting time TW2.

In step S4, the controller circuitry EC5 compares the first waiting time TW1 with the waiting time threshold TW. In a case where the controller circuitry EC5 concludes that the first waiting time TW1 is greater than or equal to the waiting time threshold TW in step S4 (see e.g., FIG. 10), the controller circuitry EC5 determines whether the controller circuitry EC5 receives the control signal CS21 or CS22 in step S5. In a case where the controller circuitry EC5 concludes that the controller circuitry EC5 has not received the control signal CS21 or CS22 in step S5, the process returns to step S1. In a case where the controller circuitry EC5 concludes that the controller circuitry EC5 has received the control signal CS21 or CS22 in step S5 (see e.g., FIG. 10), the controller circuitry EC5 determines whether the first waiting time TW1 elapses in step S6.

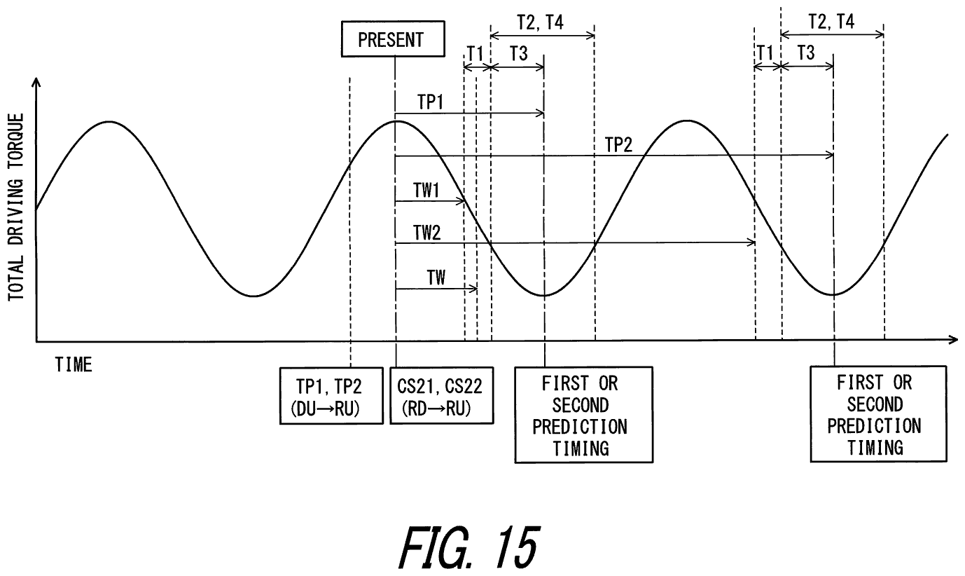

In a case where the controller circuitry EC5 concludes that the first waiting time TW1 is less than the waiting time threshold TW in step S4 (see e.g., FIG. 15), the controller circuitry EC5 compares the second waiting time TW2 with the waiting time threshold TW in step S7. In a case where the controller circuitry EC5 concludes that the second waiting time TW2 is less than the waiting time threshold TW in step S7, the process proceeds to step S1. In a case where the controller circuitry EC5 concludes that the second waiting time TW2 is greater than or equal to the waiting time threshold TW in step S7 (see e.g., FIG. 15), the controller circuitry EC5 determines whether the controller circuitry EC5 receives the control signal CS21 or CS22 in step S8. In a case where the controller circuitry EC5 concludes that the controller circuitry EC5 has not received the control signal CS21 or CS22 in step S8, the process returns to step S1. In a case where the controller circuitry EC5 concludes that the controller circuitry EC5 has received the control signal CS21 or CS22 in step S8, the controller circuitry EC5 determines whether the second waiting time TW2 elapses in step S9.

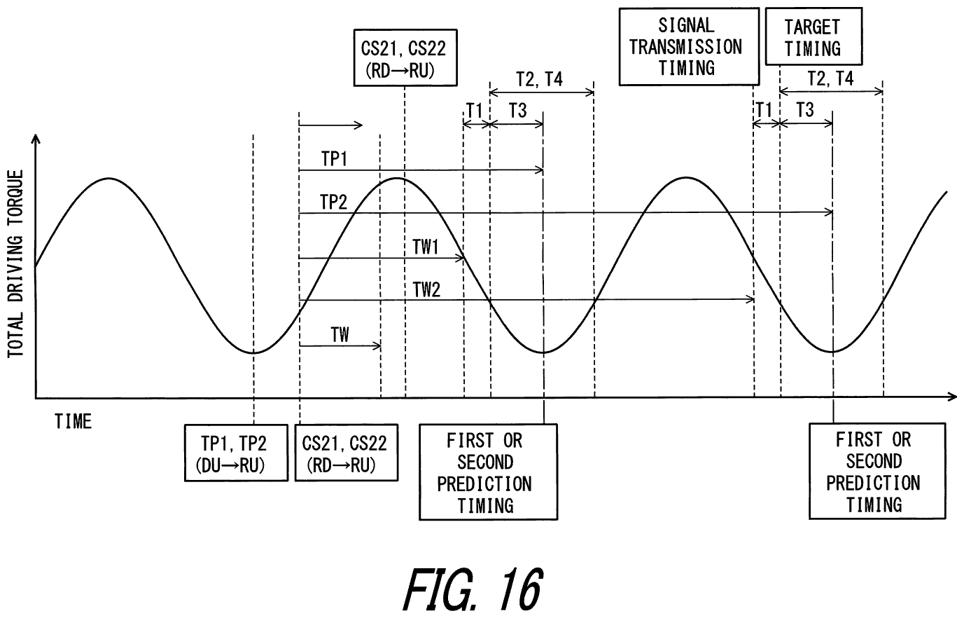

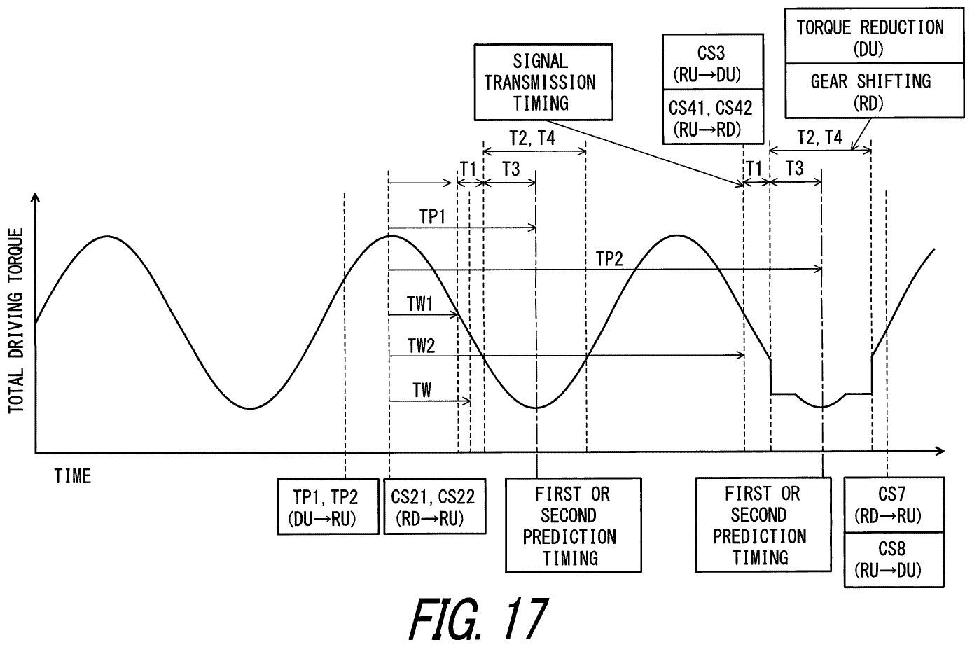

In a case where the controller circuitry EC5 concludes that the first waiting time TW1 or the second waiting time TW2 has elapsed in step S6 or S9, in step S10, the controller circuitry EC5 determines whether the controller circuitry EC5 receives the opposite control signal CS21 or CS22 which is opposite to the control signal CS21 or CS22 received in step S5 or S8. In a case where the controller circuitry EC5 concludes that the controller circuitry EC5 has received the opposite control signal CS21 or CS22 which is opposite to the control signal CS21 or CS22 received in step S5 or S8 (see e.g., FIG. 16), the process proceeds to step S1. Namely, the controller circuitry EC5 does not transmit the torque control signal CS3 and the gear-shifting signal CS41 or CS42 in a case where the controller circuitry EC5 has received the opposite control signal CS21 or CS22 before transmitting the torque control signal CS3 and the gear-shifting signal CS41 or CS42 (see e.g., FIG. 16). In a case where the controller circuitry EC5 concludes that the controller circuitry EC5 has not received the opposite control signal CS21 or CS22 which is opposite to the control signal CS21 or CS22 which is received in step S5 or S8 (see e.g., FIG. 11 or 17), the process proceeds to step S11.

As seen in FIG. 14, in step S11, the controller circuitry EC5 transmits the torque control signal CS3 to the assist drive unit DU via the first interface circuitry WC51. The first controller circuitry EC1 of the assist drive unit DU temporarily uses the temporary upper limit such than the assist torque TQ2 does not exceed the temporary upper limit for the torque reduction time T4 in response to the torque control signal CS3 (see e.g., FIG. 11 or 17).

In step S12, the controller circuitry EC5 transmits the gear-shifting signal CS41 to the transmission device RD via the second interface circuitry WC52 in a case where the controller circuitry EC5 receives the control signal CS21 or CS22 from the transmission device RD in step S5 or S8 (see e.g., FIG. 11 or 17). In step S12, the controller circuitry EC5 transmits the gear-shifting signal CS42 to the transmission device RD via the second interface circuitry WC52 in a case where the controller circuitry EC5 receives the gear-shifting signal CS42 from the transmission device RD in step S5 or S8 (see e.g., FIG. 11 or 17).

In step S15, the controller circuitry EC5 determines whether the controller circuitry EC5 receives, from the transmission device RD, the gear-stage notification signal CS7 including the current gear stage of the transmission device RD. In a case where the controller circuitry EC5 concludes that the controller circuitry EC5 has received the gear-stage notification signal CS7 in step S15, the controller circuitry EC5 stores the current gear stage included in the gear-stage notification signal CS7 in the memory EC52 in step S16.

In step S17, the controller circuitry EC5 transmits the gear-stage notification signal CS8 including the current gear stage of the transmission device RD to the assist drive unit DU via the first interface circuitry WC51. The first controller circuitry EC1 of the assist drive unit DU stores the current gear stage included in the gear-stage notification signal CS8 in the memory EC12.

In step S18, the controller circuitry EC5 stops counting down the first waiting time TW1 and the second waiting time TW2. The process returns to step S1.

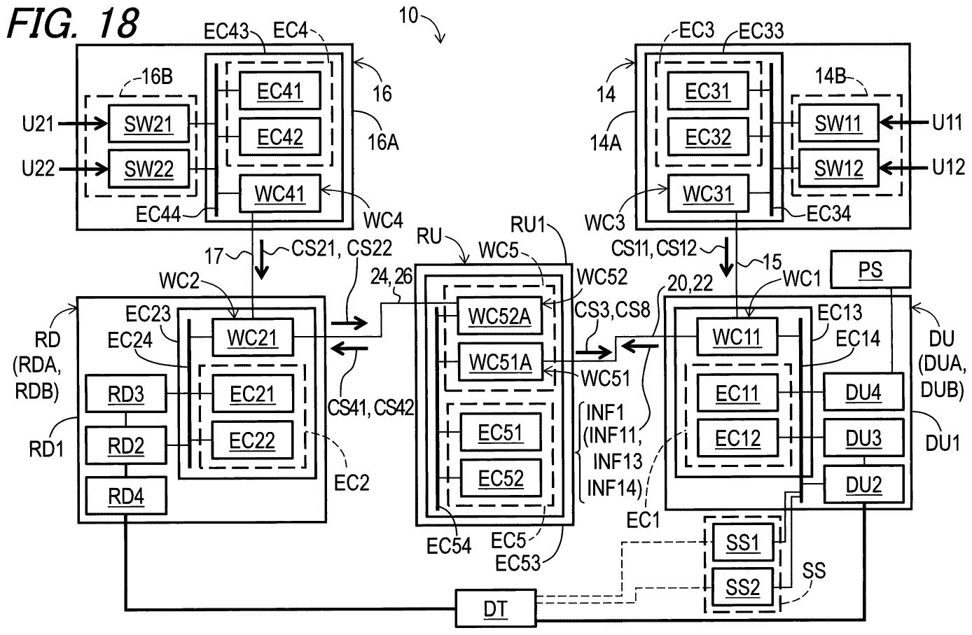

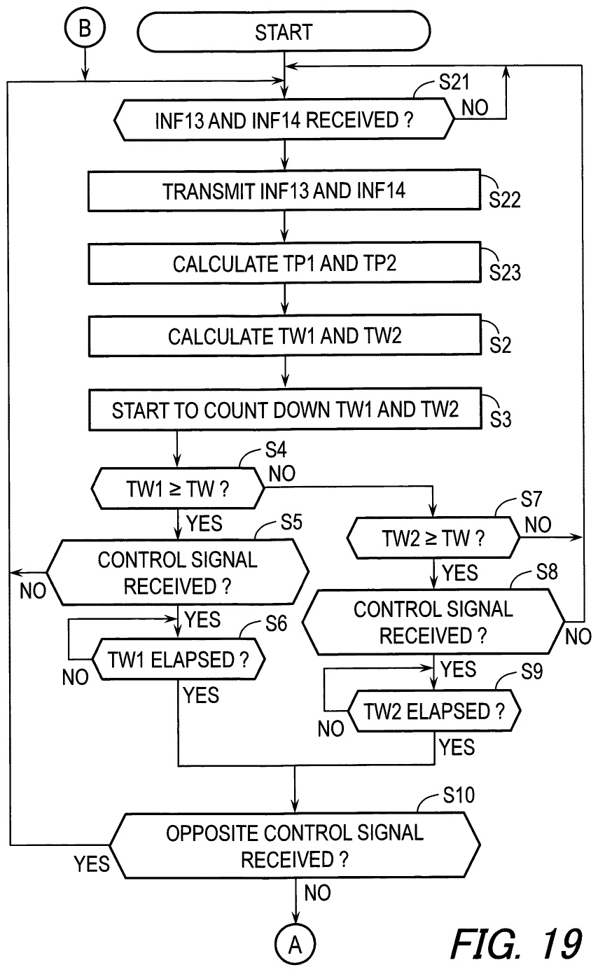

In the present embodiment, the assist drive unit DU is configured to calculate part of the information INF1 based on the output of the sensor SS. As seen in FIGS. 18 and 19, however, the relay unit RU can be configured to calculate part of the information INF1 based on the output of the sensor SS.

As seen in FIGS. 18 and 19, in this modification, the relay unit RU is configured to receive the crank information INF11 from the sensor SS via the assist drive unit DU. The crank information INF11 includes first crank information INF12 and second crank information INF13. The controller circuitry EC5 is configured to receive the first crank information INF12 from the sensor SS. The controller circuitry EC5 is configured to receive the second crank information INF13 from the sensor SS. The controller circuitry EC5 is configured to receive the first crank information INF12 from the sensor SS via the assist drive unit DU (see e.g., step S21 in FIG. 19). The controller circuitry EC5 is configured to receive the second crank information INF13 from the sensor SS via the assist drive unit DU (see e.g., step S21 in FIG. 19).

The first crank information INF12 relates to the crank CR of the human-powered vehicle B. The second crank information INF13 relates to the crank CR of the human-powered vehicle B. The first crank information INF12 relates to at least one of the pedaling torque TQ1 and the rotational position of the crank CR. The second crank information INF13 relates to at least one of the pedaling torque TQ1 and the rotational position of the crank CR. Namely, the sensor SS is configured to detect the first crank information INF12. The sensor SS is configured to detect the second crank information INF13. The relay unit RU is configured to receive the pedaling torque TQ1 and the rotational position of the crank CR from the sensor SS via the assist drive unit DU.

For example, the first crank information INF12 includes the pedaling torque TQ1 and the rotational position of the crank CR detected by the sensor SS at a first timing. The second crank information INF13 includes the pedaling torque TQ1 and the rotational position of the crank CR detected by the sensor SS at a second timing different from the first timing.

The controller circuitry EC5 is configured to transmit at least one of the first crank information INF12 and the second crank information INF13 to one of the first assist drive unit DUA, the second assist drive unit DUB and the transmission device RD via the interface circuitry WC5 (see e.g., step S22 in FIG. 19). The controller circuitry EC5 is configured to transmit the first crank information INF12 and the second crank information INF13 to one of the first assist drive unit DUA, the second assist drive unit DUB and the transmission device RD of the human-powered vehicle B via the interface circuitry WC5 (see e.g., step S22 in FIG. 19). In the present embodiment, the controller circuitry EC5 is configured to transmit the first crank information INF12 and the second crank information INF13 to the first assist drive unit DUA and the transmission device RD via the interface circuitry WC5 in a case where the relay unit RU is electrically connected to the first assist drive unit DUA and the transmission device RD. The controller circuitry EC5 is configured to transmit the first crank information INF12 and the second crank information INF13 to the second assist drive unit DUB and the transmission device RD via the interface circuitry WC5 in a case where the relay unit RU is electrically connected to the second assist drive unit DUB and the transmission device RD. The first assist drive unit DUA can be configured to generate the assist torque TQ2 based on the first crank information INF12 and the second crank information INF13. The second assist drive unit DUB can be configured to generate the assist torque TQ2 based on the first crank information INF12 and the second crank information INF13. The transmission device RD can be configured to utilize the first crank information INF12 and the second crank information INF13.

The controller circuitry EC5 is configured to calculate the first prediction time TP1 and the second prediction time TP2 based on the first crank information INF12 and the second crank information INF13 instead of the assist drive unit DU (see e.g., step S23 in FIG. 19).

The controller circuitry EC5 is configured to calculate the first waiting time TW1 and the second waiting time TW2 based on the first prediction time TP1 and the second prediction time TP2 (see e.g., step S2 in FIG. 19). Steps S2 to S10 of FIG. 19 are the same as steps S2 to S10 of FIG. 13.

The torque control signal CS3 can be referred to as a control signal CS3. The gear-shifting signal CS41 or CS42 can be referred to as a control signal CS41 or CS42. Thus, the controller circuitry EC5 is configured to, based on the first crank information INF12, generate the control signal CS3 and/or CS41 or CS42 that controls at least one of the first assist drive unit DUA, the second assist drive unit DUB and the transmission device RD of the human-powered vehicle B. The controller circuitry EC5 is configured to transmit the control signal CS3 and/or CS41 or CS42 to one of the first assist drive unit DUA, the second assist drive unit DUB and the transmission device RD of the human-powered vehicle B via the interface circuitry WC5.

For example, the controller circuitry EC5 is configured to transmit the control signal CS3 to the first assist drive unit DUA via the interface circuitry WC5 based on the control signal CS21 or CS22, the first waiting time TW1, and the second waiting time TW2 (see e.g., steps S3 to S10 of FIG. 19 and step S11 of FIG. 14) in a case where the relay unit RU is electrically connected to the first assist drive unit DUA. The controller circuitry EC5 is configured to transmit the control signal CS3 to the second assist drive unit DUB via the interface circuitry WC5 based on the control signal CS21 or CS22, the first waiting time TW1, and the second waiting time TW2 (see e.g., steps S3 to S10 of FIG. 19 and step S11 of FIG. 14) in a case where the relay unit RU is electrically connected to the second assist drive unit DUB. The controller circuitry EC5 is configured to transmit the control signal CS41 or CS42 to the transmission device RD via the interface circuitry WC5 based on the control signal CS21 or CS22, the first waiting time TW1, and the second waiting time TW2 (scc e.g., steps S3 to S10 of FIG. 19 and step S12 of FIG. 14) in a case where the relay unit RU is electrically connected to the transmission device RD.

In the present embodiment, the assist drive unit DU is configured to apply the assist torque TQ2 to the drivetrain DT. Alternatively, the assist drive unit DU can be provided to a front hub assembly, a rear hub assembly, or other parts of the human-powered vehicle B to assist propulsion of the human-powered vehicle B.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A relay unit comprising:
first interface circuitry configured to be electrically connected to an assist drive unit of a human-powered vehicle, the assist drive unit being configured to assist propulsion of the human-powered vehicle;
second interface circuitry configured to be electrically connected to a transmission device of the human-powered vehicle, the transmission device being configured to execute a gear shifting of the human-powered vehicle; and
controller circuitry electrically connected to the first interface circuitry and the second interface circuitry, the controller circuitry being configured to receive information relating to the human-powered vehicle from a sensor configured to detect the information, the controller circuitry being configured to change a timing of the gear shifting of the transmission device based on the information.

2. The relay unit according to claim 1, wherein
the controller circuitry is configured to change the timing of the gear shifting to a target timing at which pedaling torque applied to a crank of the human-powered vehicle is lower than a pedaling torque threshold.

3. The relay unit according to claim 2, wherein
the controller circuitry is configured to calculate the target timing of the gear shifting based on the information.

4. The relay unit according to claim 3, wherein
the controller circuitry is configured to transmit, to the transmission device via the second interface circuitry based on the information, a gear-shifting signal such that the transmission device executes the gear shifting at the target timing calculated by the controller circuitry.

5. The relay unit according to claim 1, wherein
the assist drive unit is configured to generate assist torque to assist the propulsion of the human-powered vehicle, and
the controller circuitry is configured to transmit, to the assist drive unit via the first interface circuitry based on the information, a torque control signal such that the assist drive unit changes the assist torque.

6. The relay unit according to claim 5, wherein
the controller circuitry is configured to transmit, to the assist drive unit via the first interface circuitry based on the information, the torque control signal such that the assist drive unit reduces the assist torque.

7. The relay unit according to claim 6, wherein
the assist drive unit is configured to limit the assist torque to an upper limit in a case where the assist torque reaches the upper limit, and
the controller circuitry is configured to transmit, to the assist drive unit via the first interface circuitry based on the information, the torque control signal such that the assist drive unit reduces the upper limit.

8. The relay unit according to claim 1, wherein
the information includes crank information relating to a crank of the human-powered vehicle, and
the controller circuitry is configured to change the timing of the gear shifting based on the crank information.

9. The relay unit according to claim 8, wherein
the crank information relates to at least one of
pedaling torque applied to the crank, and
a rotational position of the crank, and
the controller circuitry is configured to change the timing of the gear shifting based on the at least one of the pedaling torque and the rotational position.

10. The relay unit according to claim 9, wherein
the crank information relates to at least one of
a first prediction timing at which the pedaling torque becomes minimum, and
a second prediction timing at which a crank arm of the crank is positioned in one of a top dead center and a bottom dead center, and
the controller circuitry is configured to change the timing of the gear shifting based on the at least one of the first prediction timing and the second prediction timing.

11. The relay unit according to claim 1, wherein
the controller circuitry is configured to receive the information from the assist drive unit via the first interface circuitry using a first communication protocol.

12. The relay unit according to claim 11, wherein
the controller circuitry is configured to receive gear-shifting information from the transmission device via the second interface circuitry using a second communication protocol, and
the second communication protocol is different from the first communication protocol.

13. The relay unit according to claim 1, wherein
the controller circuitry is configured to receive gear-shifting information from the transmission device via the second interface circuitry, and
the gear-shifting information relates to the gear shifting of the transmission device.

14. The relay unit according to claim 13, wherein
the controller circuitry is configured to change the timing of the gear shifting of the transmission device based on the information and the gear-shifting information.

15. The relay unit according to claim 1, wherein
the controller circuitry is configured to calculate, based on the information, a signal transmission timing at which the controller circuitry transmits a gear-shifting signal to the transmission device via the second interface circuitry.

16. A relay unit comprising:
interface circuitry configured to be electrically connected to at least one of a first assist drive unit of a human-powered vehicle and a transmission device of the human-powered vehicle, the first assist drive unit being configured to assist propulsion of the human-powered vehicle, the transmission device being configured to execute a gear shifting of the human-powered vehicle, the interface circuitry being configured to be electrically connected to a second assist drive unit instead of the first assist drive unit, the second assist drive unit being different from the first assist drive unit; and
controller circuitry electrically connected to the interface circuitry and a sensor, the sensor being configured to detect first crank information relating to a crank of the human-powered vehicle, the controller circuitry being configured to receive the first crank information via the sensor, the controller circuitry being configured to transmit at least one of the first crank information and second crank information to one of the first assist drive unit, the second assist drive unit and the transmission device via the interface circuitry, the second crank information relating to the crank of the human-powered vehicle.

17. The relay unit according to claim 16, wherein
the controller circuitry is configured to transmit the first crank information and the second crank information to one of the first assist drive unit, the second assist drive unit and the transmission device of the human-powered vehicle via the interface circuitry.

18. A relay unit comprising:
interface circuitry configured to be electrically connected to at least one of a first assist drive unit of a human-powered vehicle and a transmission device of the human-powered vehicle, the first assist drive unit being configured to assist propulsion of the human-powered vehicle, the transmission device being configured to execute a gear shifting of the human-powered vehicle, the interface circuitry being electrically connectable a second assist drive unit instead of the first assist drive unit, the second assist drive unit being different from the first assist drive unit; and
controller circuitry electrically connected to the interface circuitry and a sensor, the sensor being configured to detect first crank information relating to a crank of the human-powered vehicle, the controller circuitry being configured to receive the first crank information via the sensor, the controller circuitry being configured to, based on the first crank information, generate a control signal that controls at least one of the first assist drive unit, the second assist drive unit and the transmission device of the human-powered vehicle.

19. The relay unit according to claim 18, wherein
the controller circuitry is configured to transmit the control signal to one of the first assist drive unit, the second assist drive unit and the transmission device of the human-powered vehicle via the interface circuitry.

20. A human-powered vehicle system comprising:
the relay unit according to claim 1;
the assist drive unit configured to be electrically connected to the relay unit; and
the transmission device configured to be electrically connected to the relay unit.
